(19) United States
(12) Patent Application Publication
(10) Pub. No.: US 2006/0041481 A1
(43) Pub. Date: Feb. 23, 2006

(54) Multi-package delivery methods

(76) Inventor: Robert Stowe, Manchester, CT (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/860,670

(22) Filed: Jun. 3, 2004

(51) Int. Cl. G06Q 20/00

(52) U.S. Cl. 705/16

(57) ABSTRACT

The present invention involves methods for the delivery of a plurality of parcels shipped by one or more shippers to a location via a carrier. Methods are disclosed for aggregating parcels shipped by one or more shippers for a single delivery to the location, thereby reducing the need for multiple deliveries to the same location. In one method, the dates of the shipment of the parcels are coordinated such that the plurality of parcels may be delivered substantially simultaneously to the customer. In another method, some parcels are delayed in their shipping route while others may be expedited such that the plurality of parcels are delivered substantially simultaneously to the location by the carrier.

### BACKGROUND OF THE INVENTION

1. Field of the Invention

The field of the invention is package (a/k/a “parcel”) delivery by a parcel delivery service (a/k/a “carrier”). More specifically, the field of the invention is methods of aggregating multiple parcels intended for delivery at a location into a minimum number of deliveries at that location.

2. Description of Related Art

In may instances, carriers such as, for example, UPS, FedEx, etc. may make multiple deliveries to a single location on a single day, or within a time span of a few days. This involves the carrier loading the parcels that comprise each delivery onto a package car or other transportation device, transporting the parcels to their destined location, off-loading the parcels and delivering them to the location. Often, this last leg of the delivery process is the one that is the least efficient and most costly to the carriers. One way to reduce costs and inefficiencies is to have the customer pick up their parcels are a distribution facility; however, this may be inconvenient for the customer and not provide the level of service desired by the customer. Preferably, systems and methods can be found that reduce the costs and inefficiencies associated with this last leg of the delivery process yet providing a high level of service to the carrier's customers.

### BRIEF SUMMARY OF THE INVENTION

The present invention provides systems and methods to aggregate the delivery of multiple parcels to a location such that the number of deliveries to that location decreases and the number of parcels in each delivery increases. In various embodiments, shippers may be provided with discounted shipping rates or monetary rebates if they cooperate with the carrier such that one or more shippers may have one or more shipped parcels aggregated for delivery to a location.

For example, if a customer orders an item from a shipper and the shipper is going to ship a second parcel via ground transportation and there is only two days ground time in transit from the shipper to the location, but there is already a first parcel in transit that would be delivered on the third day to the location, the customer may be asked to wait an additional day to get the second parcel so that it may be aggregated for delivery with the first parcel. As another example, if there is a first parcel that's in transit and scheduled to be delivered the next day, the customer may be able to get a next-day air package for the second parcel so that the first and second parcels may be aggregated for delivery to the customer. In some instances, the customer may be provided shipping discounts through the shipper that may offset the cost of a higher class of delivery service (e.g., next-day air). These and other embodiments of the invention are described in greater detail herein.

One aspect of the invention is a method of aggregating the delivery of parcels to a customer by a carrier. The method is comprised of the steps of placing a first parcel in a first shipping route to the customer. The first parcel has a known first delivery date. An expected second delivery date of a second parcel in a second shipping route to the customer if said second parcel is shipped immediately is then determined. If the expected second delivery date is earlier than said first delivery date, then the shipment of the second parcel is delayed such that the expected second delivery date coincides with the first delivery date and the first parcel and the second parcel are delivered in a single delivery to the customer on the first delivery date.

Another aspect of the invention is another method of aggregating the delivery of parcels to a customer by a carrier. This method is comprised of the steps of first placing a first parcel in a first shipping route to the customer. The first parcel has a known first delivery date. Then, a second parcel is placed in a second shipping route to the customer. The second parcel has a second delivery date that is different from the first delivery date. If the second delivery date is later than said first delivery date, then delivery of the second parcel is expedited by using a higher class of service offered by the carrier for the second parcel such that the second delivery date coincides with the first delivery date and the first parcel and the second parcel are delivered in a single delivery to the customer on the first delivery date.

Yet another aspect of the invention is another method of aggregating the delivery of parcels to a customer by a carrier. This method is comprised of the steps of shipping a first parcel to the customer, the first parcel having a known first delivery date. Then, an expected second delivery date of a second parcel is determined if the second parcel is immediately shipped to the customer. If the expected second delivery date is before the first delivery date then shipment of the second parcel is delayed such that the expected second delivery date coincides with the first delivery date and the first parcel and the second parcel are delivered in a single delivery to the customer on the first delivery date. If the expected second delivery date is after the first delivery date then the second parcel is shipped and delivery of the second parcel is expedited by using a higher class of service offered by the carrier for the second parcel such that the expected second delivery date coincides with the first delivery data and the first parcel and the second parcel are delivered in a single delivery to the customer on the first delivery date.

Another aspect of the invention is a method of aggregating the delivery of parcels to a customer by a carrier. This method is comprised of the steps of placing a first parcel having a known first delivery date in a first shipping route to the customer. A second parcel is then placed in a second shipping route to the customer. The second parcel also has a known second delivery date, but that is different from the first delivery date. If the second delivery date is later than said first delivery date, then delivery of the first parcel is delayed by the carrier such that the second delivery date coincides with the first delivery date and the first parcel and the second parcel are delivered in a single delivery to the customer on the second delivery date.

Another aspect of the invention is a method of delivering parcels. This method is comprised of the steps of first, placing a first parcel in a first shipping route to a location. The first parcel has a first package tracking identifier and a first delivery date. Then, a second parcel is placed in a second shipping route to the location. The second parcel has a second package tracking identifier and a second delivery date. Finally, either of the first or second parcels are delayed along their respective shipping routes so that they arrive at the location at substantially the same time.

Yet another aspect of the invention is a method of delivering a plurality of parcels to a customer via a carrier. This method is comprised of the steps of first, coordinating a shipment date for each of a plurality of parcels shipped by one or more shippers to a customer on a substantially consistent time interval such that the plurality of parcels are delivered to the customer by the carrier at substantially the same time. Then, the plurality of parcels that are shipped from one or more shippers on each parcels designated shipment date are received by the carrier and delivered to the customer at substantially the same time.

The embodiments of the present invention provide a customer-convenient, efficient and cost-effective means of combining a plurality of parcels intended for delivery at a specific location by a carrier into a minimum number of deliveries at that location. The above aspects of the present invention and other additional aspects are described more thoroughly below.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1a is an illustration of one embodiment of a computer that can be used to practice aspects of the present invention;

FIG. 1b is an embodiment of a processing system having a distributed communication and processing architecture that may be used to practice aspects of the present invention;

FIG. 2 is a flowchart that shows an embodiment of a process for delivering a plurality of packages by a carrier intended for the same location on the same day and with the same carrier package car by coordinating shipper shipments;

FIG. 3 is a flowchart that shows an embodiment of a process for delivering a plurality of packages by a carrier intended for the same location, on the same day and with the same carrier package car by coordinating shipper shipments or by the carrier managing the delivery date;

FIG. 4 is an alternative embodiment of the process shown in the flowchart of FIG. 3;

FIG. 5 is a flowchart showing an embodiment of a process for delivering a plurality of packages by a carrier intended for the same location, on the same day and with the same carrier package car by coordinating shipper shipments or by the carrier managing the delivery date;

FIG. 6 is a flowchart showing an embodiment of a process for delivering a plurality of packages by a carrier intended for the same location on the same day and with the same carrier package car by coordinating shipper shipments or by the carrier managing the delivery date;

FIG. 7 is a diagrammatic representation of the components of an embodiment of a system for implementing aspects of the invention, and the interrelationship between the various components that comprise this embodiment;

FIG. 8 is a diagrammatic representation of the components of an embodiment of a system for implementing aspects of the invention, wherein the aggregation of the packages or parcels is performed by the carrier, and the interrelationship between the various components that comprise this embodiment.

FIG. 9 is an alternative embodiment of the diagrammatic representation of the components of the system shown in FIG. 8;

FIG. 10 is a diagrammatic representation of the components of a embodiment of a system for implementing the embodiments of the invention, wherein the aggregation of the packages is performed by the carrier, and the interrelationship between the various components of the system;

FIG. 11 is an embodiment of a system for substantially simultaneously delivering a plurality of packages containing items that have been ordered in separate orders from one or more vendors to a customer that has ordered the items;

FIG. 12 is an embodiment of a system for substantially simultaneously delivering a plurality of packages containing items that have been ordered in separate orders from one or more vendors to a customer that has ordered the items;

FIG. 13 is a flowchart that shows the steps for aggregating multiple packages for a single delivery to a customer, in an embodiment of the invention, wherein the packages are shipped on a substantially consistent basis and a carrier coordinates the shippers' shipment date;

FIG. 14 is another flowchart that describes the steps for aggregating multiple packages for a single delivery to a customer, in an embodiment of the invention, wherein the packages are shipped on a substantially consistent basis and a carrier coordinates the shippers' shipment date;

FIG. 15 is another flowchart that describes the steps for aggregating multiple packages for a single delivery to a customer, in an embodiment of the invention, wherein the packages are shipped on a substantially consistent basis and a carrier coordinates the shippers' shipment date;

FIG. 16 is another flowchart that describes the steps for aggregating multiple packages for a single delivery to a customer, in an embodiment of the invention, wherein the packages are shipped on a substantially consistent basis and a carrier coordinates the shippers' shipment date;

FIG. 17 is a flowchart that describes the steps for aggregating multiple packages for a single delivery to a customer, in an embodiment of the invention, wherein the packages are shipped on a substantially consistent basis and a carrier coordinates the delivery date of the packages;

FIG. 18 is a flowchart that describes the steps for aggregating multiple packages for a single delivery to a customer, in an embodiment of the invention, wherein the packages are shipped on a substantially consistent basis and a carrier coordinates the delivery date of the packages;

FIG. 19 is a flowchart that describes the steps for aggregating multiple packages for a single delivery to a customer, in an embodiment of the invention, wherein the packages are shipped on a substantially consistent basis and a carrier coordinates the delivery date of the packages;

FIG. 20 is a flowchart that describes the steps for aggregating multiple packages for a single delivery to a customer, in an embodiment of the invention, wherein the packages are shipped on a substantially consistent basis and a carrier coordinates the delivery date of the packages;

FIG. 21 is a flowchart that describes the steps for aggregating multiple packages for a single delivery to a customer, in an embodiment of the invention, wherein the packages are shipped on a substantially consistent basis and a carrier coordinates the delivery date of the packages;

FIG. 22 is a diagrammatic representation of the components of an embodiment of a system for implementing aspects of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system;

FIG. 23 is a diagrammatic representation of the components of an embodiment of a system for implementing aspects of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system;

FIG. 24 is a diagrammatic representation of the components of an embodiment of a system for implementing aspects of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system;

FIG. 25 is a diagrammatic representation of the components of an embodiment of a system for implementing aspects of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system;

FIG. 26 is a diagrammatic representation of the components of an embodiment of a system for implementing aspects of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system.

FIG. 27 is a diagrammatic representation of the components of an embodiment of a system for implementing aspects of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system;

FIG. 28 is a diagrammatic representation of the components of an embodiment of a system for implementing aspects of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system;

FIG. 29 is a diagrammatic representation of the components of an embodiment of a system for implementing aspects of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system;

FIG. 30 is an embodiment of a system for substantially simultaneously delivering a plurality of packages containing items that have been ordered in separate orders from one or more vendors to a customer that has ordered the items; and

FIG. 31 is an embodiment of a system for substantially simultaneously delivering a plurality of packages containing items that have been ordered in separate orders from one or more vendors to a customer that has ordered the items

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The embodiments of the present invention are directed toward systems and methods to aggregate the delivery of multiple packages by a package delivery service (a/k/a “carrier”) such that the carrier can reduce the need to make multiple trips to the intended recipient's location. The parties to a shipping transaction include a shipper such as, for example, a vendor; a carrier such as, for example, United Parcel Service (UPS); and an intended recipient (a/k/a “customer”). In various embodiments of the invention, a customer that has one or more packages in transit in one or more shipping routes and via the carrier may request the shipper of a later-shipped package to delay shipment of that package or to use a higher class of service (e.g., air delivery versus ground transportation) such that the one or more packages, including the later-shipped package, can be aggregated by the carrier and arrive via the same carrier's package car at the customer's location, regardless of the shipping route used by the packages. In other embodiments, the packages being shipped to a certain location may be held for consolidation at a carrier facility (e.g., a pre-load facility) and merged into one shipment to the certain location. The carrier may provide incentives for the shippers and/or the customers to utilize the aggregated shipping methods and systems such as, for example, discounted shipping rates and/or monetary rebates.

Other embodiments of the invention involve shipments from one or more shippers to an intended recipient wherein such shipments are made on substantially consistent time intervals. An example would be a collector who receives monthly shipments of assorted collectibles, with the deliveries occurring at various times throughout the month. The collector may prefer to have all the deliveries made in one package car delivery to the collector's location. In one embodiment, the carrier may coordinate with the shippers to ship on various days and with various service classes such that all the shipments arrive at the collector's location on the same day and in the same carrier's package car, regardless of the shipping routes through which the shipments passed. In another embodiment, the carrier may arrange a delivery date with the collector and delay or accelerate the shipment of various items such that the plurality of shipped items arrive at the collector's location on the same day and in the same package car. The carrier may provide incentives for the shippers and/or the customers to utilize the aggregated shipping methods and systems.

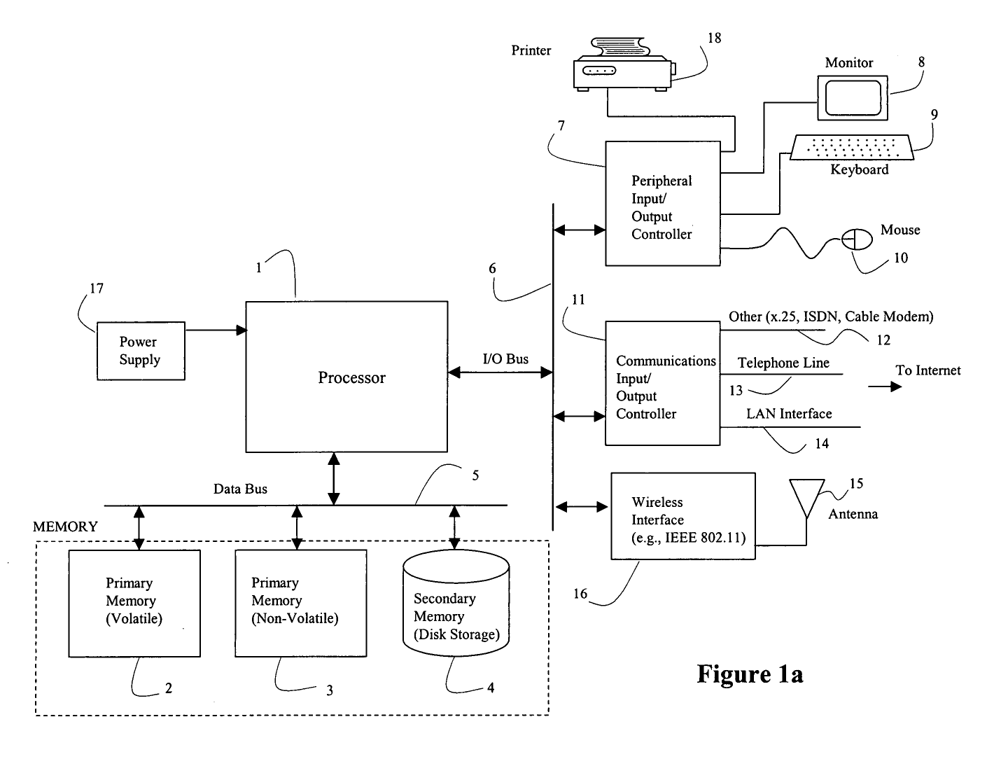

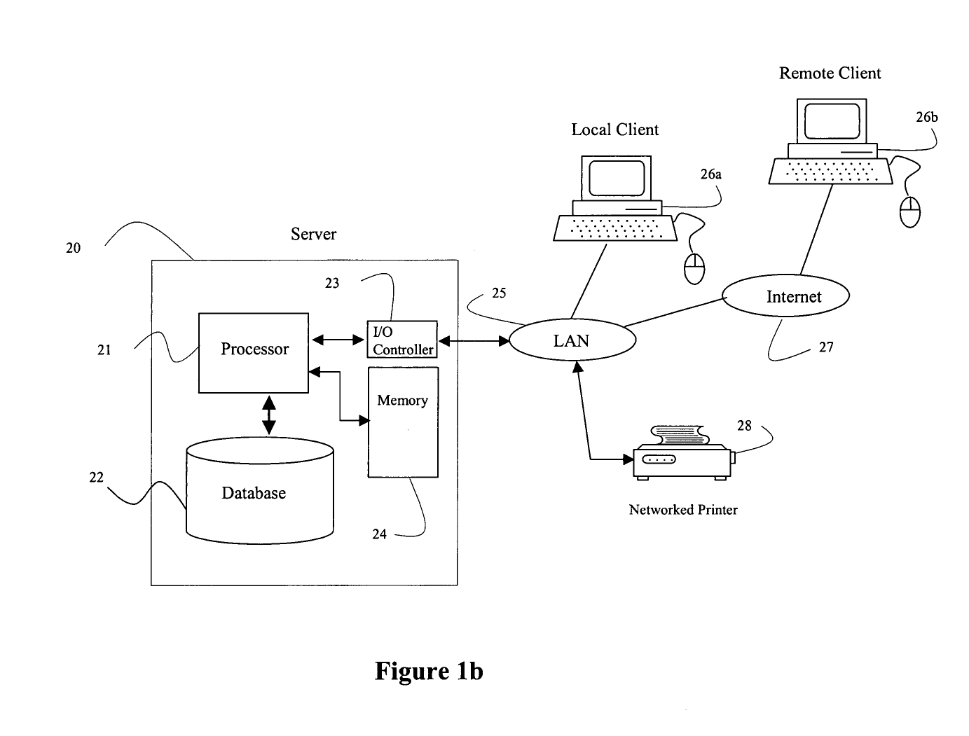

In several of the embodiments referenced herein, a “computer” is referenced. The computer may be, for example, a mainframe, desktop, notebook or laptop, hand-held, etc. In some instances the computer may be a “dumb” terminal used to access data or processors over a network. Turning to FIG. 1a, one embodiment of a computer is illustrated that can be used to practice aspects of the present invention. In FIG. 1a, a processor 1, such as a microprocessor, is used to execute software instructions for carrying out the defined steps. The processor receives power from a power supply 17 that also provide power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4, such as disk storage, that stores large amount of data. In some embodiments, the disk storage may communicate with the processor using an I/O bus 6 instead or a dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc.).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access the Internet, intranets, LANs, or other data communication facilities.

Finally, the processor 1 may communicate with a wireless interface 16 that is operatively connected to an antenna 15 for communicating wirelessly with another devices, using for example, one of the IEEE 802.11 protocols, 802.15.4 protocol, or a standard 3G wireless telecommunications protocols, such as CDMA2000 1x EV-DO, GPRS, W-CDMA, or other protocol.

An alternative embodiment of a processing system that may be used is shown in FIG. 1b. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, as well as primary memory 24. The processor also communicates with external devices using an I/O controller 23 that typically interfaces with a LAN 25. The LAN may provide local connectivity to a networked printer 28 and the local client computer 26a. . These may be located in the same facility as the server, though not necessarily in the same room. Communication with remote devices typically is accomplished by routing data from the LAN 25 over a communications facility to the Internet 27. A remote client computer 26b may execute a web browser, so that the remote client 26b may interact with the server as required by transmitted data through the Internet 27, over the LAN 25, and to the server 20.

Those skilled in the art of data networking will realize that many other alternatives and architectures are possible and can be used to practice the principles of the present invention. The embodiments illustrated in FIGS. 1a and 1b can be modified in different ways and be within the scope of the present invention as claimed.

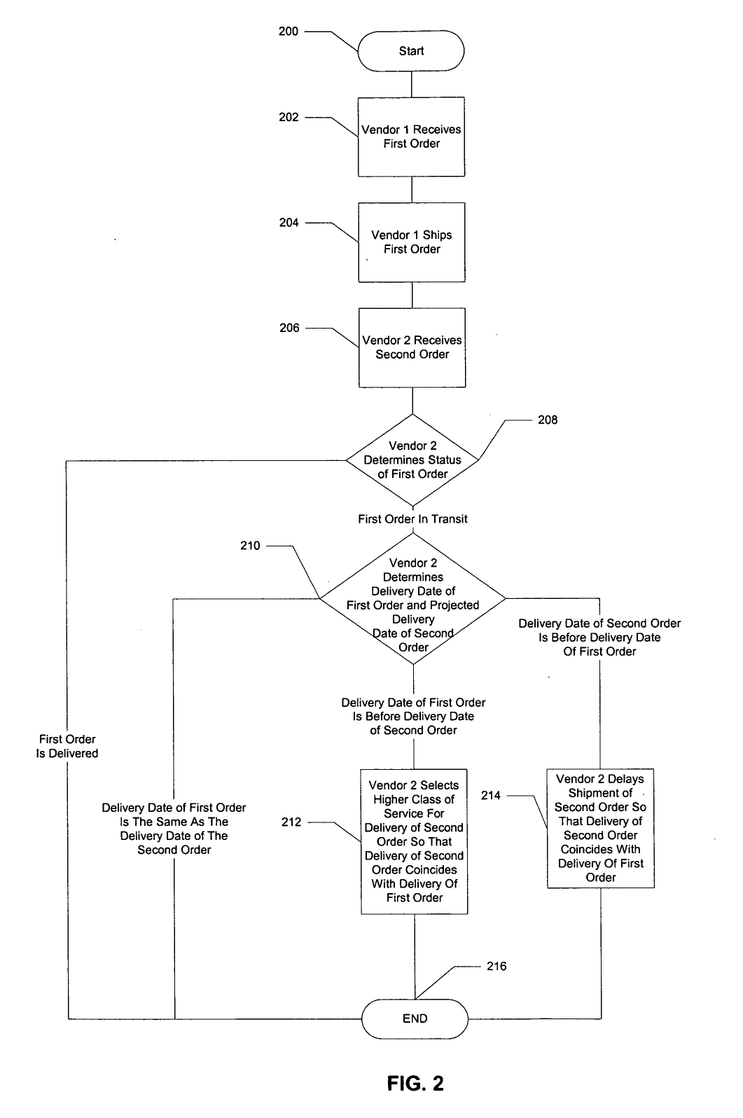

FIG. 2 is a flowchart describing a process for delivering a plurality of packages by a carrier intended for the same location on the same day and with the same carrier package car by coordinating shipper shipments. The process of FIG. 2 begins at Step 200. At Step 202, a first vendor or shipper (“Vendor 1”) receives an order or request to ship (“First Order”) from a customer. In response to the First Order, Vendor 1 ships the items that comprise the First Order to the customer via a carrier, as described in Step 204. At Step 206, a second vendor or shipper (“Vendor 2”) receives an order or request to ship (“Second Order”) from the customer. The customer also provides Vendor 2 with information about the First Order such that Vendor 2 can access the carrier's tracking system and determine the status of the First Order, as shown in Step 208. If it is determined by Vendor 2 that the First Order has been delivered to the customer, then the process ends at Step 216. If Vendor 2 determines from the carrier's tracking system that the First Order is in transit to the customer, then at Step 210 Vendor 2 determines from the carrier's tracking system the (expected) delivery date of the First Order and the (projected) delivery date of the Second Order. If the expected delivery date of the First Order is the same as the projected delivery date of the Second Order, then the process ends at Step 216. If the expected delivery date of the First Order is before the projected delivery date of the Second Order, then if it is feasible for a higher class of the carrier's delivery service (e.g., going from three-day delivery to overnight, etc.) to allow the delivery of the First Order and the Second Order to the customer at the same time, then as described in Step 212, Vendor 2 selects the higher class of service for the delivery of the Second Order so that the delivery of the Second Order coincides with the delivery of the First Order to the customer. If the expected delivery date of the First Order is after the projected delivery date of the Second Order, then in Step 214 Vendor 2 delays shipment of the Second Order until such time that the delivery of the Second Order will coincide with the delivery of the First Order to the customer. The process ends at Step 216.

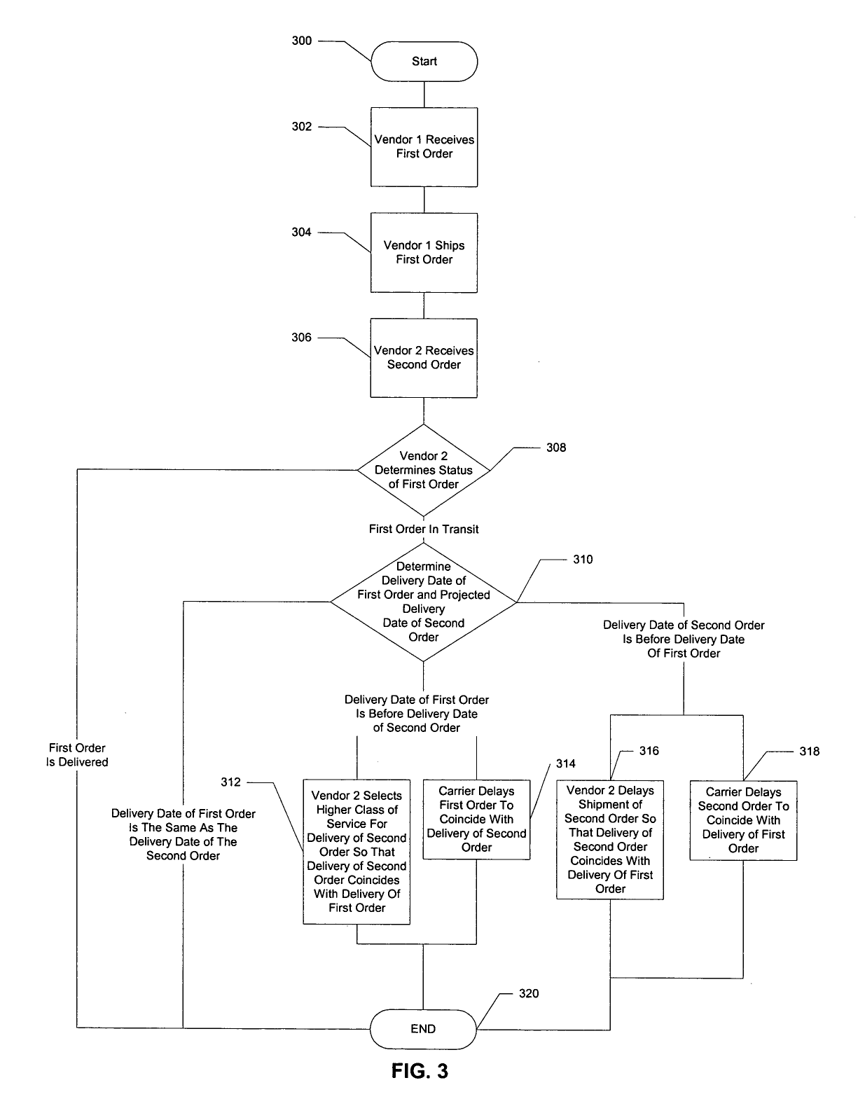

FIG. 3 is a flowchart describing a process for delivering a plurality of packages by a carrier intended for the same location, on the same day and with the same carrier package car by coordinating shipper shipments or by the carrier managing the delivery date. The process of FIG. 3 begins at Step 300. At Step 302, a first vendor or shipper (“Vendor 1m”) receives an order or request to ship (“First Order”) from a customer. In response to the First Order, Vendor 1 ships the items that comprise the First Order to the customer via a carrier, as described in Step 304. At Step 306, a second vendor or shipper (“Vendor 2”) receives an order or request to ship (“Second Order”) from the customer. The customer also provides Vendor 2 with information about the First Order such that Vendor 2 can access the carrier's tracking system and determine the status of the First Order, as shown in Step 308. If it is determined by Vendor 2 that the First Order has been delivered to the customer, then the process ends at Step 320. If Vendor 2 determines from the carrier's tracking system that the First Order is in transit to the customer, then at Step 310 Vendor 2 determines from the carrier's tracking system the (expected) delivery date of the First Order and the (projected) delivery date of the Second Order. If the expected delivery date of the First Order is the same as the projected delivery date of the Second Order, then the process ends at Step 320. If the expected delivery date of the First Order is before the projected delivery date of the Second Order, then there are two options. Option 1, as shown in Step 312, is if it is feasible for a higher class of the carrier's delivery service (e.g., going from three-day delivery to overnight, etc.) to allow the delivery of the First Order and the Second Order to the customer at the same time, then Vendor 2 selects the higher class of service for the delivery of the Second Order so that the delivery of the Second Order coincides with the delivery of the First Order to the customer, or a second option is possible. The second option, as shown in Step 314, is for the carrier to delay the delivery of the First Order so that the First Order and the Second Order are aggregated for (one) delivery to the customer. If the expected delivery date of the First Order is after the projected delivery date of the Second Order, then there are also two available options in the process of FIG. 3. The first option, as shown in Step 316, is for Vendor 2 to delay shipping the Second Order until such time that the delivery of the Second Order will coincide with the delivery of the First Order to the customer. The second option, as shown in Step 318, is for the carrier to delay delivery of the Second Order so that the Second Order and the First Order are aggregated for (one) delivery to the customer. The process ends at Step 320.

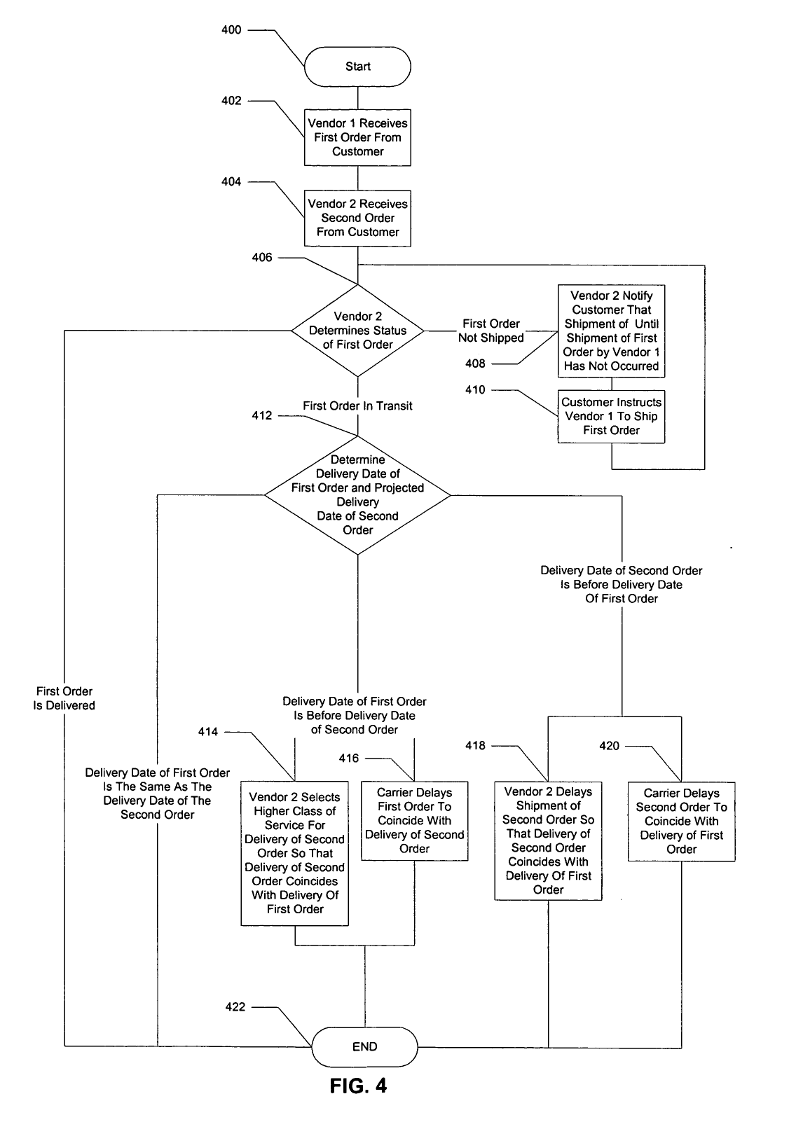

FIG. 4 is a variant of the processes described in FIGS. 2 and 3. FIG. 4, like FIG. 3, is a flowchart describing a process for delivering a plurality of packages by a carrier intended for the same location, on the same day and with the same carrier package car by coordinating shipper shipments or by the carrier managing the delivery date. The process of FIG. 4 begins at Step 400. At Step 402, a first vendor or shipper (“Vendor 1”) receives an order or request to ship (“First Order”) from a customer. At Step 404, a second vendor or shipper (“Vendor 2”) receives an order or request to ship (“Second Order”) from the customer. The customer also provides Vendor 2 with sufficient information about the First Order such that Vendor 2 can access the carrier's tracking system and determine the status of the First Order, as shown in Step 406. If it is determined by Vendor 2 that the First Order has been delivered to the customer, then the process ends at Step 422. If it is determined by Vendor 2 that the First Order has not been shipped by Vendor 1, then at Step 408 Vendor 2 notifies the customer that the shipment of the First Order by Vendor 1 has not occurred. At Step 410, the customer instructs Vendor 1 to ship the first order and the process returns to Step 406. If, at Step 406, Vendor 2 determines from the carrier's tracking system that the First Order is in transit to the customer, then at Step 412 Vendor 2 determines from the carrier's tracking system the (expected) delivery date of the First Order and the (projected) delivery date of the Second Order. If the expected delivery date of the First Order is the same as the projected delivery date of the Second Order, then the process ends at Step 422. If the expected delivery date of the First Order is before the projected delivery date of the Second Order, then there are two options. Option 1, as shown in Step 414, is if it is feasible for a higher class of the carrier's delivery service (e.g., going from three-day delivery to overnight, etc.) to allow the delivery of the First Order and the Second Order to the customer at the same time, then Vendor 2 selects the higher class of service for the-delivery of the Second Order so that the delivery of the Second Order coincides with the delivery of the First Order to the customer, or a second option is possible. The second option, as shown in Step 416, is for the carrier to delay the delivery of the First Order so that the First Order and the Second Order are aggregated for (one) delivery to the customer. If the expected delivery date of the First Order is after the projected delivery date of the Second Order, then there are also two available options in the process of FIG. 4. The first option, as shown in Step 418, is for Vendor 2 to delay shipping the Second Order until such time that the delivery of the Second Order will coincide with the delivery of the First Order to the customer. The second option, as shown in Step 420, is for the carrier to delay delivery of the Second Order so that the Second Order and the First Order are aggregated for (one) delivery to the customer. The process ends at Step 422.

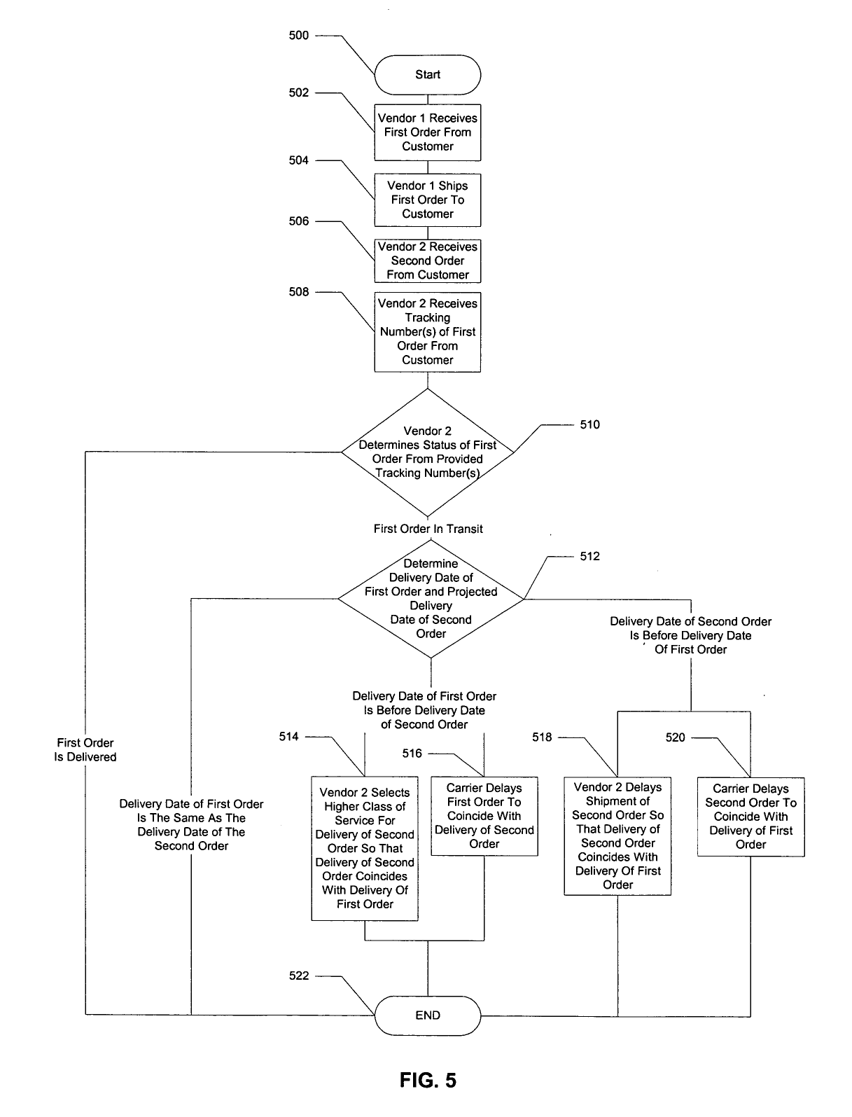

FIG. 5 is also a variant of the processes described in FIGS. 2, 3 and 4. FIG. 5 is a flowchart describing a process for delivering a plurality of packages by a carrier intended for the same location, on the same day and with the same carrier package car by coordinating shipper shipments or by the carrier managing the delivery date. The process of FIG. 5 begins at Step 500. At Step 502, a first vendor or shipper (“Vendor 1”) receives an order or request to ship (“First Order”) from a customer. In response to the First Order, Vendor 1 ships the items that comprise the First Order to the customer via a carrier, as described in Step 504. At Step 506, a second vendor or shipper (“Vendor 2”) receives an order or request to ship (“Second Order”) from the customer. At Step 508, the customer provides Vendor 2 with sufficient information such as, for example, a package tracking number or code, about the First Order such that Vendor 2 can access the carrier's tracking system and determine the status of the First Order. If at Step 510 it is determined by Vendor 2 that the First Order has been delivered to the customer, then the process ends at Step 522. If, at Step 510, Vendor 2 determines from the carrier's tracking system that the First Order is in transit to the customer, then at Step 512 Vendor 2 determines from the carrier's tracking system the (expected) delivery date of the First Order and the (projected) delivery date of the Second Order. If the expected delivery date of the First Order is the same as the projected delivery date of the Second Order, then the process ends at Step 522. If the expected delivery date of the First Order is before the projected delivery date of the Second Order, then there are two options. Option 1, as shown in Step 514, is if it is feasible for a higher class of the carrier's delivery service (e.g., going from three-day delivery to overnight, etc.) to allow the delivery of the First Order and the Second Order to the customer at the same time, then Vendor 2 selects the higher class of service for the delivery of the Second Order so that the delivery of the Second Order coincides with the delivery of the First Order to the customer, or a second option is possible. The second option, as shown in Step 516, is for the carrier to delay the delivery of the First Order so that the First Order and the Second Order are aggregated for (one) delivery to the customer. If the expected delivery date of the First Order is after the projected delivery date of the Second Order, then there are also two available options in the process of FIG. 5. The first option, as shown in Step 518, is for Vendor 2 to delay shipping the Second Order until such time that the delivery of the Second Order will coincide with the delivery of the First Order to the customer. The second option, as shown in Step 520, is for the carrier to delay delivery of the Second Order so that the Second Order and the First Order are aggregated for (one) delivery to the customer. The process ends at Step 522.

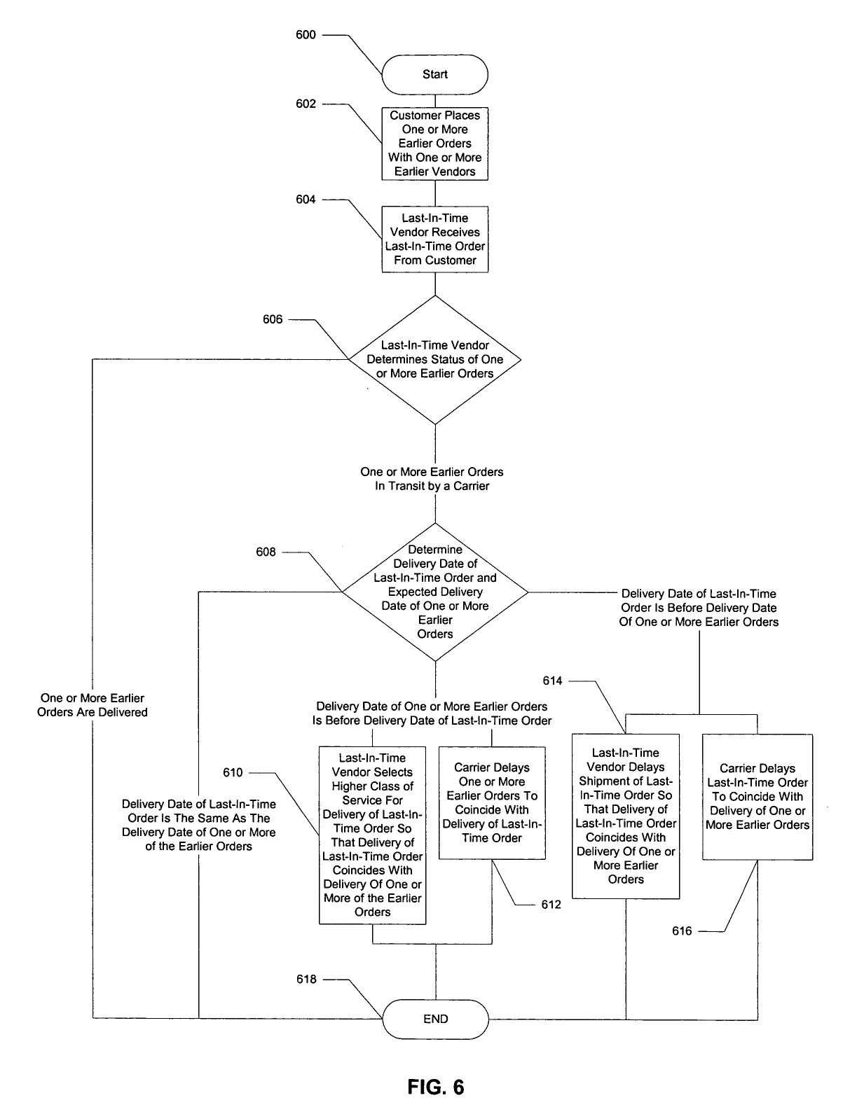

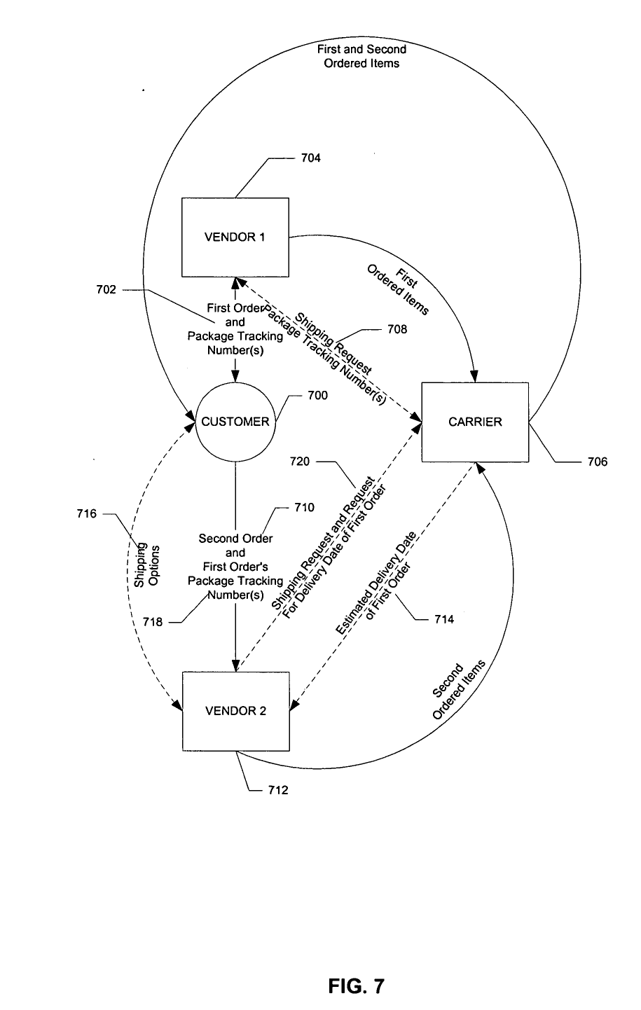

FIG. 6 is a flowchart describing a process for delivering a plurality of packages by a carrier intended for the same location, on the same day and with the same carrier package car by coordinating shipper shipments or by the carrier managing the delivery date. The process of FIG. 6 begins at Step 600. At Step 602, a customer places one or more orders (“Earlier Orders”) with one or more vendors or shippers (“Earlier Vendors”). The customer then places an order for one or more items with a last vendor or shipper (“Last-In-Time Vendor”) at Step 604. The customer provides the Last-In-Time Vendor with sufficient information about the Earlier Orders such that the Last-In-Time Vendor can access the carrier's tracking system and determine the status of each of the Earlier Orders, as shown in Step 606. If it is determined by the Last-In-Time Vendor that all the Earlier Orders have been delivered to the customer, then the process ends at Step 618. If the Last-In-Time Vendor determines from the carrier's tracking system that one or more of the Earlier Orders are in transit to the customer, then at Step 608, the Last-In-Time Vendor determines from the carrier's tracking system the (expected) delivery date(s) of the one or more Earlier Orders and the (projected) delivery date of the Last-In-Time Order. If the expected delivery date of the one or more Earlier Orders is the same as the projected delivery date of the Last-In-Time Order, then the process ends at Step 618. If the expected delivery date of the one or more Earlier Orders is before the projected delivery date of the Last-In-Time Orders, then there are two options. Option 1, as shown in Step 610, is if it is feasible for a higher class of the carrier's delivery service (e.g., going from three-day delivery to overnight, etc.) to allow the delivery of the one or more Earlier Orders and the Last-In-Time Order to the customer at the same time, then the Last-In-Time Vendor selects the higher class of service for the delivery of the Last-In-Time Order so that the delivery of the Last-In-Time Order coincides with the delivery of one or more of the Earlier Orders to the customer, or a second option is possible. The second option, as shown in Step 612, is for the carrier to delay the delivery of one or more of the Earlier Orders so that one or more of the Earlier Orders and the Last-In-Time Order are aggregated for (one) delivery to the customer. If the expected delivery date of one or more of the Earlier Orders is after the projected delivery date of the Last-In-Time Order, then there are also two available options in the process of FIG. 6. The first option, as shown in Step 614, is for the Last-In-Time Vendor to delay shipping the Last-In-Time Order until such time that the delivery of the Last-In-Time Order will coincide with the delivery of one or more of the Earlier Orders to the customer. The second option, as shown in Step 616, is for the carrier to delay delivery of the Last-In-Time Order so that the Last-In-Time Order and one or more of the Earlier Orders are aggregated for (one) delivery to the customer. The process ends at Step 618. 10030 FIG. 7 is a diagrammatic representation of the components of a system for implementing the embodiments of the invention, and the interrelationship between the various components. A customer 700 places a first order 702 with a first vendor (“Vendor 1”) 704. The order may be placed over a network such as, for example, the Internet, or a telephone system, or it may be placed by the customer 700 while at the vendor's facility, or by any other means by which an order may be placed. The network may be wired, wireless, optical or any combination thereof. Vendor 1 704 will then prepare the customer's order for shipment and will contact a carrier 706 to make a shipping request 708, or Vendor 1 704 will have a pre-existing business arrangement with the carrier 706 for the shipment of Vendor l's packages. The items that comprise the first order 702 are then presented to the carrier 706 for shipping. The carrier 706 may pick-up the items, or they may be dropped off to the carrier 706. Once the first order 702 is shipped, Vendor 1 704 provides the customer 700 with information about the shipment, including the package tracking information about the one or more items that comprise the first order 702. The customer 700 then places a second order 710. The second order 710 is generally placed with a separate vendor (“Vendor 2”) 712, though it may be the same vendor (Vendor 1) 704 that received the first order 702. The customer 700 also provides Vendor 2 712 with package tracking information 718 about the first order 702. Vendor 2 712 will then access the carrier 706 to obtain delivery information about the first order 702 and to request shipment 720 of the second order 710. Vendor 2 712 will receive an expected delivery date 714 of the first order 702 from the carrier 706. From the information provided to Vendor 2 712 by the carrier 706, Vendor 2 712 is able to present various shipping options 716 to the customer 700. For example, Vendor 2 712 may offer the customer 700 discounted shipping if the customer 700 agrees to either allow Vendor 2 712 to delay shipment of the second order 710 or expedite the shipment of the second order 710 such that the delivery of the second order 710 coincides with the delivery of the first order 710 and both orders may be delivered simultaneously to the customer 700 by the carrier 706.

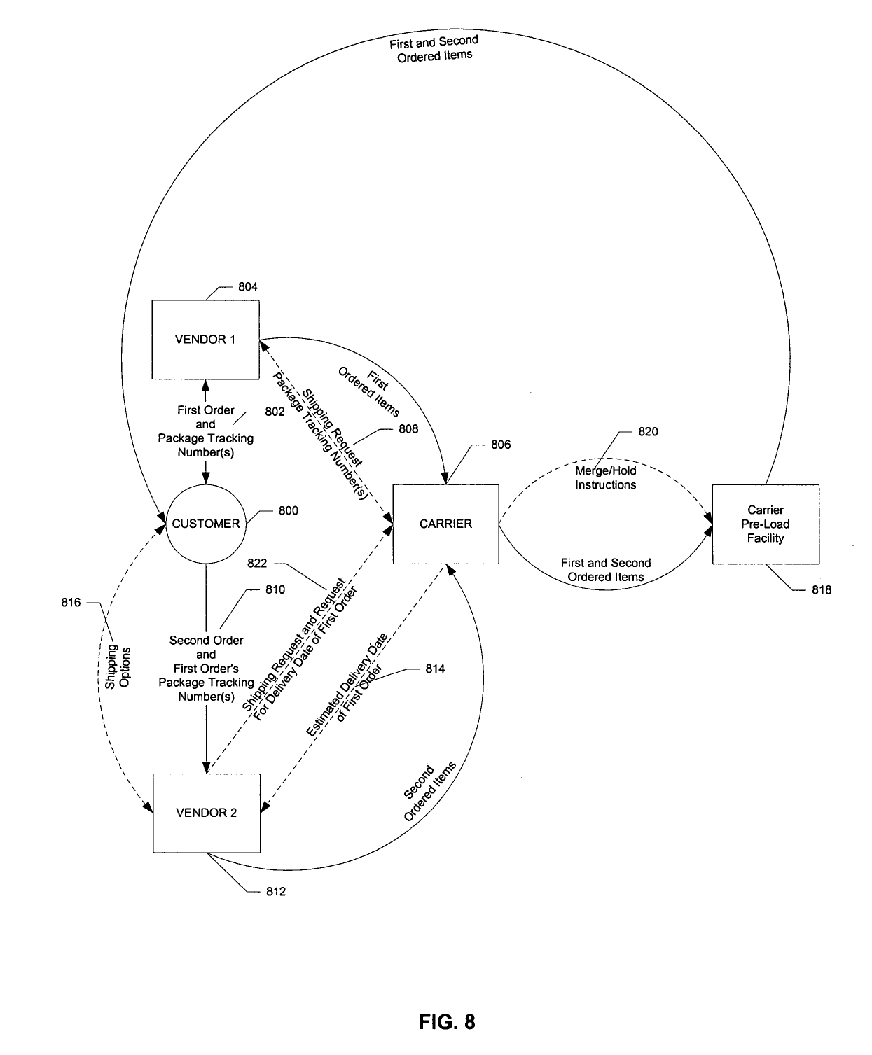

FIG. 8 is a diagrammatic representation of the components of a system for implementing the embodiments of the invention, wherein the aggregation of the packages is performed by the carrier, and the interrelationship between the various components of the system. A customer 800 places a first order 802 with a first vendor (“Vendor 1”) 804. The order may be placed over a network such as, for example, the Internet, or a telephone system, it may be placed by the customer 800 while at the vendor's facility, or by any other means by which an order may be placed. The network may be wired, wireless, optical or any combination thereof. Vendor 1 804 will then prepare the customer's order for shipment and will contact a carrier 806 to make a shipping request 808, or Vendor 1 804 will have a pre-existing business arrangement with the carrier 806 for the shipment of Vendor 1's packages. The items that comprise the first order 802 are then presented to the carrier 806 for shipping. The carrier 806 may pick-up the items, or they may be dropped off to the carrier 806. Once the first order 802 is shipped, Vendor 1 804 provides the customer 800 with information about the shipment, including the package tracking information about the one or more items that comprise the first order 802. The customer 800 then places a second order 810. The second order 810 is generally placed with a separate vendor (“Vendor 2”) 812, though it may be the same vendor (Vendor 1) 804 that received the first order 802. The customer 800 also provides Vendor 2 812 with package tracking information 818 about the first order 802. Vendor 2 812 will then access the carrier 806 to obtain delivery information about the first order 802 and to request shipment 822 of the second order 810. Vendor 2 812 will receive an expected delivery date 814 of the first order 802 from the carrier 806. From the information provided to Vendor 2 812 by the carrier 806, Vendor 2 812 may be able to present various shipping options 816 to the customer 800. For example, Vendor 2 812 may offer the customer 800 discounted shipping if the customer 800 agrees to either allow the carrier 806 to delay delivery of the second order 810 or expedite the shipment of the second order 810 such that the delivery of the second order 810 coincides with the delivery of the first order 802 and both orders may be delivered simultaneously to the customer 800 by the carrier 806.

As shown in the embodiment of FIG. 8, packages for delivery are sent to a carrier's pre-load facility. At this location, packages go through their final sort, routed, prepared for delivery, and placed on the carrier's transport vehicle such as, for example, a package car. Generally, pre-load facilities are operated by the carrier, though they may be operated independently. A carrier may have multiple pre-load facilities. In the embodiment of FIG. 8, the packages that comprise the first order 802 and the second order 810 are sent to the same pre-load facility 818, though the first order 802 may arrive before the second order 810, the second order 810 may arrive before the first order 802 or the first order 802 and the second order 810 may arrive simultaneously. If the first order 802 arrives at the pre-load facility 818 before the second order 810, the carrier 806 issues a merge/sort order 820 to the pre-load facility. The merge/sort order indicates that the packages that comprise the first order 802 and the second order 810 are to be merged into one order at the pre-load facility. The merge/sort order 820 also indicates that, in this instance, the first order 802 is to be held at the pre-load facility 816 until it can be combined with the second order 810.

Likewise, if the second order 810 arrives at the pre-load facility 816 before the first order 802, the carrier 806 will issue a merge/sort order 820. The merge/sort order 820 indicates that the packages that comprise the first order 802 and the second order 810 are to be merged into one order at the pre-load facility 818. The merge/sort order 820 also indicates that, in this instance, the second order 810 is to be held at the pre-load facility 818 until it can be combined with the first order 802. The combined orders 802, 810 are then delivered substantially simultaneously to the customer 800.

If the first order 802 and the second order 810 arrive at the pre-load facility 818 substantially simultaneously, either by happenstance, expediting the shipment (e.g. upgrading the class of service) of one or both of orders one 802 and two 810, by delaying shipment and/or delivery of one or both of orders one 802 and two 810, or combinations thereof, the orders 802, 810 will be delivered substantially simultaneously to the customer 800.

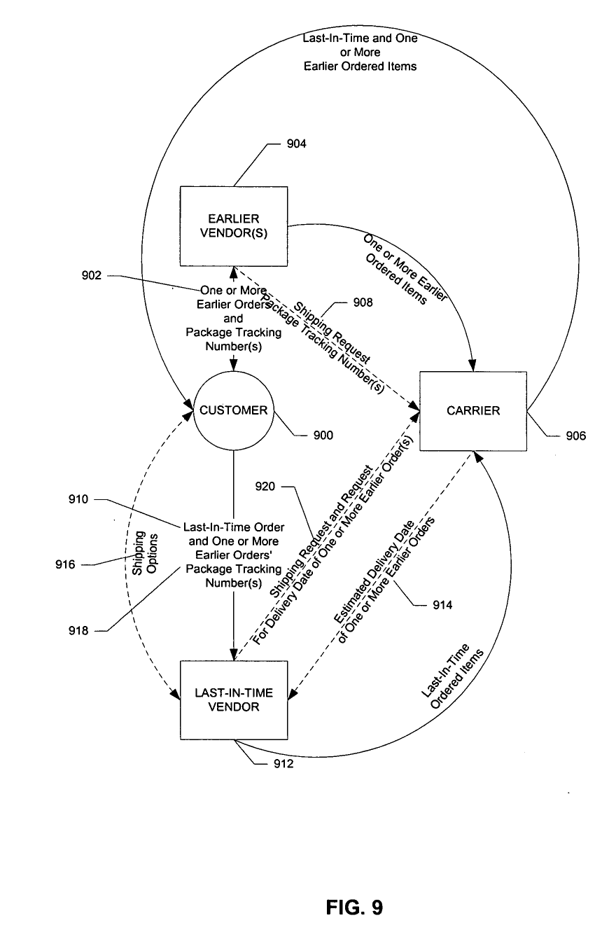

FIG. 9 is another diagrammatic representation of the components of a system for implementing the embodiments of the invention, and the interrelationship between the various components. The embodiment of FIG. 9 involves one or more earlier orders with one or more earlier vendors and a last-in-time order placed with a last-in-time vendor that may, or may not, be one of the earlier vendors. The orders, the earlier orders and the last-in-time order, are placed by a customer and delivered substantially simultaneously to the customer by a carrier.

More specifically, in the embodiment of FIG. 9, a customer 900 places one or more earlier orders 902 with one or more vendors (“Earlier Vendor(s)”) 904. The orders may be placed over a network such as, for example, the Internet, or a telephone system, by the customer 900 while at vendors' facilities, by combinations thereof, or by any other means by which orders may be placed. The network may be wired, wireless, optical or any combination thereof. The one or more Earlier Vendor(s) 904 will then prepare the customer's orders for shipment and will contact a carrier 906 to make a shipping request 908, or one or more of the Earlier Vendor(s) 904 may have a pre-existing business arrangement with the carrier 906 for the shipment of packages. The items that comprise one or more of the Earlier Orders 902 are presented to the carrier 906 for shipping. The carrier 906 may pick-up the items, or they may be dropped off to the carrier 906. Once one or more of the Earlier Orders 902 are shipped, the one or more Earlier Vendor 904 that has shipped their order to the customer 900 provides the customer 900 with information about the shipment, including the package tracking information about the one or more items that comprise the Earlier Vendor's order. The customer may place several orders with several different vendors.

The customer 900 then places a last-in-time order 910. The last-in-time order 910 is generally placed with a separate vendor (“Last-In-Time Vendor”) 912, though it may be one of the same vendors (Earlier Vendor(s)) 904 that received one or more of the Earlier Orders 902. The customer 900 also provides the Last-In-Time Vendor 912 with package tracking information 918 about the one or more Earlier Orders 902. The Last-In-Time Vendor 912 will then access the carrier 906 to obtain delivery information about the one or more Earlier Orders 902 and to request shipment 920 of the Last-In-Time Order 910. The Last-In-Time Vendor 912 will receive an expected delivery date 914 of each the Earlier Orders 902 (of which the Last-In-Time Vendor has been made aware) from the carrier 906. From the information provided to the Last-In-Time Vendor 912 by the carrier 906, the Last-In-Time Vendor 912 is able to present various shipping options 916 to the customer 900. For example, the Last-In-Time Vendor 912 may offer the customer 900 discounted shipping if the customer 900 agrees to either allow the Last-In-Time Vendor 912 to delay shipment of the Last-In-Time Order 910 or expedite the shipment of the Last-In-Time Order 910 such that the delivery of the Last-In-Time Order 910 coincides with the delivery of one or more of the Earlier Orders 910 and the aggregated orders may be delivered simultaneously to the customer 900 by the carrier 906.

If there are more than one Earlier Orders 902, the carrier 906 may want to determine whether any of the Earlier Orders 902 have received a discount for aggregated delivery. This may be accomplished by flagging or otherwise indicating in the information stored in the carrier's databases about each package shipped (a/k/a “package level detail”) that the packages that comprise one of the Earlier Orders 902 have received a discount or have been combined with one or more other orders for delivery. In this manner, the carrier may provide progressive discounts when multiple (more than two) orders are delivered simultaneously, and such flagging also helps prevent circumventing the system. For instance, if the customer has just made a second order, then in accordance with the embodiments described above (when there are only first and second orders), the second order may be eligible for a shipping discount. If the customer then places a third order and makes the third vendor aware of the shipping information of the first two orders, then the customer may be eligible for a graduated shipping discount on the third order, or the customer may not be eligible for a discount since the customer received a discount on the second order. In either circumstance, however, by flagging packages that have received discounts for aggregated delivery in the carrier's package level information, the carrier is able to determine if additional orders shipped to the customer are eligible for discounted shipping and, if so, how much discount. The “flag” used in the carrier's databases may be coded in one embodiment so that the carrier can determine if the discount provided to the packages was for aggregating the order with one other order, two other orders, three other orders, etc. In the manner described above, the carrier can provide discounts (or not provide any discount) for multiple orders (more than two) delivered substantially simultaneously to the same customer.

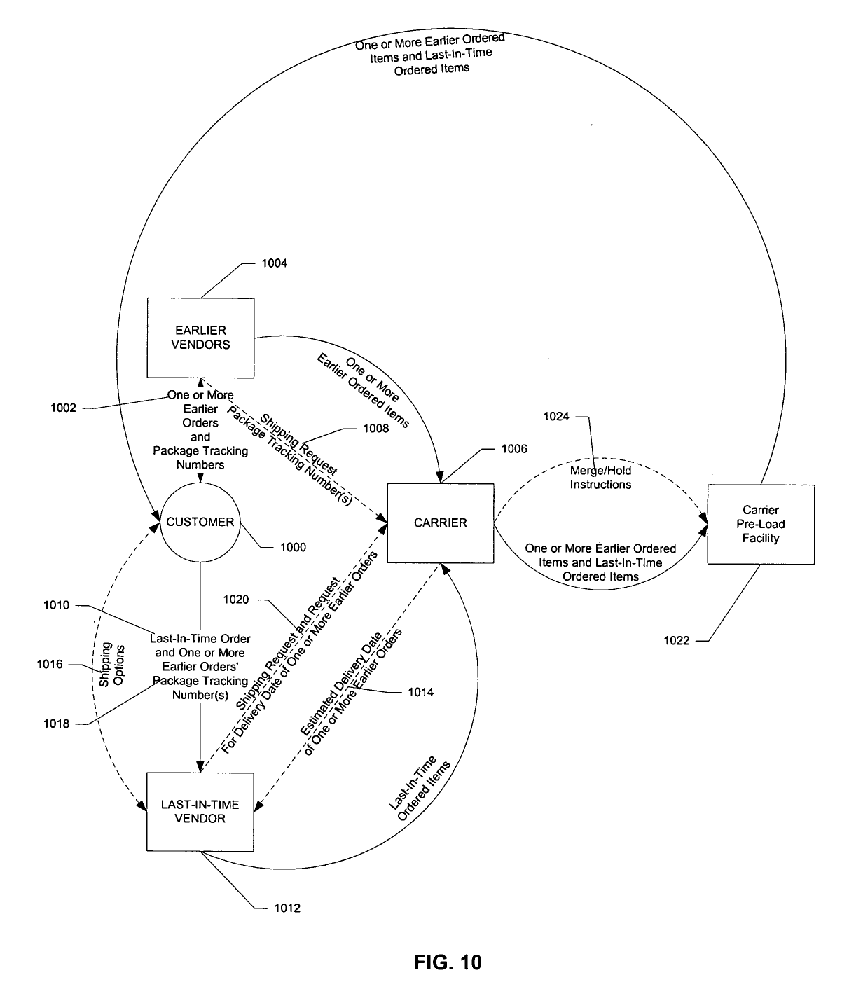

FIG. 10 is a diagrammatic representation of the components of a system for implementing the embodiments of the invention, wherein the aggregation of the packages is performed by the carrier, and the interrelationship between the various components of the system. A customer 1000 places one or more Earlier Orders 1002 with one or more earlier vendors (“Earlier Vendor(s)) 1004. The orders may be placed over a network such as, for example, the Internet, or a telephone system, they may be placed by the customer 1000 while at the vendors' facilities, or by any other means by which orders may be placed. The network may be wired, wireless, optical or any combination thereof. The one or more Earlier Vendor(s) 1004 will then prepare the customer's order for shipment and will contact a carrier 1006 to make a shipping request 1008, or one or more of the Earlier Vendor(s) 1004 will have a pre-existing business arrangement with the carrier 1006 for the shipment of the vendor's packages. The items that comprise the one or more Earlier Orders 1002 are then presented to the carrier 1006 for shipping. The carrier 1006 may pick-up the items, or they may be dropped off to the carrier 1006. Once the one or more earlier orders 1002 are shipped, each of the one or more Earlier Vendors 1004 provide the customer 1000 with information about the shipment, including the package tracking information about the one or more items that comprise each of the one or more Earlier Orders 1002. The customer 1000 then places a Last-In-Time Order 1010. The Last-In-Time Order 1010 is generally placed with a vendor that is separate (“Last-In-Time Vendor”) 1012 from the Earlier Vendors 1004, though it may be one of the Earlier Vendors 1004 that received one or more of the Earlier Orders 1002. The customer 1000 also provides the Last-In-Time Vendor 1012 with package tracking information 1018 about one or more of the Earlier Orders 1002. The Last-In-Time Vendor 1012 will then access the carrier 1006 to obtain delivery information about the one or more Earlier Orders 1002 and to request shipment 1020 of the Last-In-Time order 1010. The Last-In-Time Vendor 1012 will receive an expected delivery date 1014 of each of the Earlier Orders 1002 from the carrier 1006. From the information provided to the Last-In-Time Vendor 1012 by the carrier 1006, the Last-In-Time Vendor 1012 may be able to present various shipping options 1016 to the customer 1000. For example, the Last-In-Time Vendor 1012 may offer the customer 1000 discounted shipping if the customer 1000 agrees to either allow the carrier 1006 to delay delivery of the Last-In-Time Order 1010 or expedite the shipment of the Last-In-Time Order 1010 such that the delivery of the Last-In-Time Order 1010 coincides with the delivery of one or more of the Earlier Orders 1002 and the orders may be delivered substantially simultaneously to the customer 1000 by the carrier 1006.

As shown in the embodiment of FIG. 10, as in FIG. 8, packages for delivery are sent to a carrier's pre-load facility where they go through their final sort, routed, prepared for delivery, and placed on the carrier's transport vehicle such as, for example, a package car. In the embodiment of FIG. 10, the packages that comprise one or more of the Earlier Orders 1002 and the Last-In-Time Order 1010 are sent to the same pre-load facility 1022, though one or more of the Earlier Orders 1002 may arrive before the Last-In-Time Order 1010, the Last-In-Time Order 1010 may arrive before one or more of the Earlier Orders 1002 or one or more of the Earlier Orders 1002 and the Last-In-Time Order 1010 may arrive simultaneously at the pre-load facility 1022. If one or more of the Earlier Orders 1002 arrive at the pre-load facility 1022 before the Last-In-Time Order 1010, the carrier 1006 issues a merge/sort order 1024 to the pre-load facility 1022. The merge/sort order-1024 indicates that the packages that comprise one or more of the Earlier Orders 1002 and the Last-In-Time Order 1010 are to be merged into one order at the pre-load facility 1022. The merge/sort order 1024 also indicates that, in this instance, one or more of the Earlier Orders 1002 are to be held at the pre-load facility 1022 until it can be combined with the Last-In-Time Order 1010.

Likewise, if the Last-In-Time Order 1010 arrives at the pre-load facility 1022 before the one or more Earlier Orders 1002, the carrier 1006 will issue a merge/sort order 1024. The merge/sort order 1024 indicates that the packages that comprise the one or more Earlier Orders 1002 and the Last-In-Time Order 1010 are to be merged into one order at the pre-load facility 1022. The merge/sort order 1024 also indicates that, in this instance, the Last-In-Time Order 1010 is to be held at the pre-load facility 1022 until it can be combined with the one or more Earlier Orders 1002. The combined orders 1002, 1010 are then delivered substantially simultaneously to the customer 1000.

If the one or more Earlier Orders 1002 and the Last-In-Time Order 1010 arrive at the pre-load facility 1022 substantially simultaneously, either by happenstance, expediting the shipment (e.g. upgrading the class of service) of the one or more Earlier Orders 1002 and the Last-In-Time Order 1010, by delaying shipment and/or delivery of one or both of the one or more Earlier Orders 1002 and the Last-In-Time Order 1010, or combinations thereof; the orders 1002, 1010 will be delivered substantially simultaneously to the customer 1000.

In the embodiment of FIG. 10, if there are more than one Earlier Orders 1002, the carrier 1006 may want to determine whether any of the Earlier Orders 1002 have received a discount for aggregated delivery. This may be accomplished by flagging or otherwise indicating in the package level detail information stored in the carrier's databases about each package shipped that the packages that comprise one of the Earlier Orders 1002 have received a discount or have been combined with one or more other orders for delivery. In this manner, the carrier 1006 may provide progressive discounts when multiple (more than two) orders are delivered simultaneously, and such flagging also helps prevent circumventing the system. For instance, if the customer 1000 has just made a second order, then in accordance with the embodiments described above (when there are only first and second orders), the second order may be eligible for a shipping discount. If the customer 1000 then places a third order and makes the third vendor aware of the shipping information of the first two orders, then the customer 1000 may be eligible for a graduated shipping discount on the third order, or the customer 1000 may not be eligible for a discount on the third order since the customer 1000 received a discount on the second order. In either circumstance, however, by flagging packages that have received discounts for aggregated delivery in the carrier's package level information, the carrier 1006 is able to determine if additional orders shipped to the customer 1000 are eligible for discounted shipping and, if so, how much discount. The “flag” used in the carrier's databases may be coded in one embodiment so that the carrier can determine if the discount provided to the packages was for aggregating the order with one other order, two other orders, three other orders, etc. In the manner described above, the carrier 1006 can provide discounts (or not provide any discount) for multiple orders (more than two) delivered substantially simultaneously to the same customer 1000.

FIG. 11 is a system for substantially simultaneously delivering a plurality of packages containing items that have been ordered in separate orders from one or more vendors to a customer that has ordered the items. A customer 1100 places one or more earlier orders with one or more earlier vendors (“Earlier Vendor(s)) 1102. The orders may be placed over a network 1104 such as, for example, the Internet by use of a computer or interface device 1106, or a telephone system by use of a telephone device 1108, by combinations thereof, or by any other means of communicating over a network 1104. Also, orders may be placed by the customer 1100 while at the vendors' facilities, or by any other means by which orders may be placed.

The network 1108 may be wired, wireless, optical or any combination thereof. The network 1108 may utilize the Internet, direct connection, electronic data exchange, local area networking, wide area networking, digital, analog, combinations of any of these elements, etc.

Once the one or more Earlier Vendor(s) 1102 have received one or more orders from a customer 1100, the one or more Earlier Vendor(s) 1102 will then prepare the customer's order for shipment and will contact a carrier 1110 to make a shipping request 1008, or one or more of the Earlier Vendor(s) 1102 will have a pre-existing business arrangement with the carrier 1110 for the shipment of the vendor's packages. The items that comprise the one or more earlier orders are then presented to the carrier 1110 for shipping. Generally, the carrier 1110 will pick-up the items to be shipped by use of a package car 1112, as shown in FIG. 11. In other embodiments, the items to be shipped may be dropped off to the carrier 1110.

Once the one or more earlier ordered items are received by the carrier 1110 for shipping, information about each package is maintained by the carrier 1110. This information is generally stored in a computer controlled by the carrier 1110, such as a carrier server 1114. Information about each package includes a package tracking identifier such as a package tracking number that uniquely identifies each package being shipped. In the embodiments of FIG. 11, the Earlier Vendor(s) 1102 provide the customer 1100 with the package tracking information of each package that comprises the earlier orders. This information is generally provided over the network 1108, though it may be provided by other means such as orally or in writing.

The customer 1100 then places a last-in-time order with a Last-In-Time Vendor 1116 in the manner that an order is described as being placed, above. The Last-In-Time Vendor 1115 is generally a vendor that is separate from the Earlier Vendors 1102, though it may be one of the Earlier Vendors 1102 that received one or more of the earlier orders. The customer 1100 also provides the Last-In-Time Vendor 1116 with the package tracking information about the one or more earlier orders. This may be performed by entering certain package identifying information in a field at the Last-In-Time Vendor's 1116 website, keying in information over a touch-tone phone system, using an interactive voice recognition system, providing the information to a representative of the Last-In-Time Vendor 1116, etc.

The Last-In-Time Vendor 1116 will then use the customer-provided information to access the carrier 1110 to obtain delivery information about the one or more earlier orders and to request shipment of the last-in-time order. The carrier 1110 may be accessed over the network 1108 and via the carrier's website, by telephone, or by any other means of obtaining package tracking information from the carrier 1110. The Last-In-Time Vendor 1116 will receive an expected delivery date of each of the earlier orders from the carrier 1110. From the information provided to the Last-In-Time Vendor 1116 by the carrier 1110, the Last-In-Time Vendor 1116 may be able to present various shipping options to the customer 1100 for the last-in-time order or the earlier orders. For example, the Last-In-Time Vendor 1116 may offer the customer 1100 discounted shipping if the customer 1100 agrees to either allow the carrier 1110 to delay delivery of the last-in-time order or expedite the shipment of the last-in-time order such that the delivery of the last-in-time order coincides with the delivery of one or more of the earlier orders and the combined orders may be delivered substantially simultaneously to the customer 1100 by the carrier 1110.

In the embodiment of FIG. 11, if there are more than one earlier orders, the carrier 1110 may want to determine whether any of the earlier orders have already received a discount for aggregated delivery. This may be accomplished by flagging or otherwise indicating in the package level detail information stored in the carrier's databases about each package shipped that the packages that comprise one of the earlier orders have received a discount or have been combined with one or more other orders for delivery. In this manner, the carrier 1110 may provide progressive discounts when multiple (more than two) orders are delivered simultaneously, and such flagging also helps prevent circumventing the system. For instance, if the customer 1100 has just made a second order, then in accordance with the embodiments described above (when there are only first and second orders), the second order may be eligible for a shipping discount. If the customer 1100 then places a third order and makes the third vendor aware of the shipping information of the first two orders, then the customer 1100 may be eligible for a graduated shipping discount on the third order, or the customer 1100 may not be eligible for a discount since the customer received a discount on the second order. In either circumstance, however, by flagging packages that have received discounts for aggregated delivery in the carrier's package level information, the carrier 1110 is able to determine if additional orders shipped to the customer 1100 are eligible for discounted shipping and, if so, how much discount. The “flag” used in the carrier's databases may be coded in one embodiment so that the carrier 1110 can determine if the discount provided to the packages was for aggregating the order with one other order, two other orders, three other orders, etc. In the manner described above, the carrier 1110 can provide discounts (or not provide any discount) for multiple orders (more than two) delivered substantially simultaneously to the same customer 1100.

Once the information about the earlier orders is received by the Last-In-Time Vendor 1116, the Last-In-Time Vendor 1116 may keep any discounts offered by the carrier 1110 or the Last-In-Time Vendor 1116 may share or pass all the benefits to the customer 1100. If the Last-In-Time Vendor 1116 decides to provide the customer 1100 with the shipping discount or to share the discounts with the customer 1100, then the shipping options are presented to the customer 1100 by, for example, displaying them on the Last-In-Time Vendor's website, emailing them to the customer 1100, reciting the options to the customer 1100 over the telephone, or otherwise audibly or visually making the customer 1100 aware of the shipping options. Under one option, the customer is provided the opportunity to combine the delivery of the last-in-time order with one or more of the earlier orders. This may be accomplished by the Last-In-Time Vendor 1116 delaying the shipment of the last-in-time order such that the delivery of the last-in-time order coincides with the delivery of one or more of the earlier orders to the customer 1100, thus reducing the delivery trips by the carrier 1110 to the customer 1100. Another option would be for the customer 1100 to choose to upgrade the class of service (e.g., go from three-day ground to next-day air) of the last-in-time order. In this manner, the last-in-time order may be combined with one or more of the earlier orders by the carrier 1110 and delivered substantially simultaneously to the customer 1100 by the carrier 1110.

Once the shipping options are selected by the customer 1100 (if made available to the customer), the items that comprise the last-in-time order are presented to the carrier 1110 for shipment. Generally, the items are picked-up by the carrier 1110 at the Last-In-Time Vendor's place of business and transported to a carrier facility by a package car 1112, though in other embodiments the items may be dropped off at the carrier's facility. The items that comprise the last-in-time order will be aggregated with items that comprise one or more of the earlier orders will be transported. The aggregated orders will then be loaded on a package car 1112 or other means for transporting the aggregated orders to the customer 1100, transported to the customer 1100, and delivered substantially simultaneously.

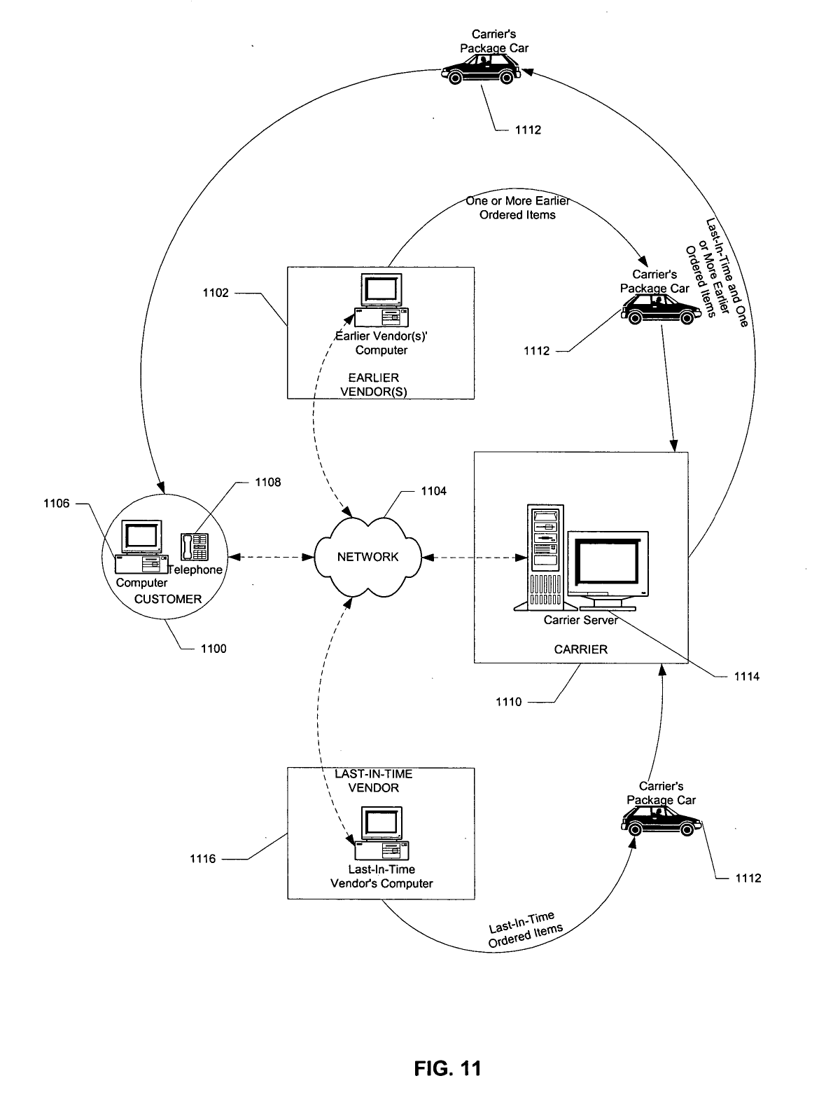

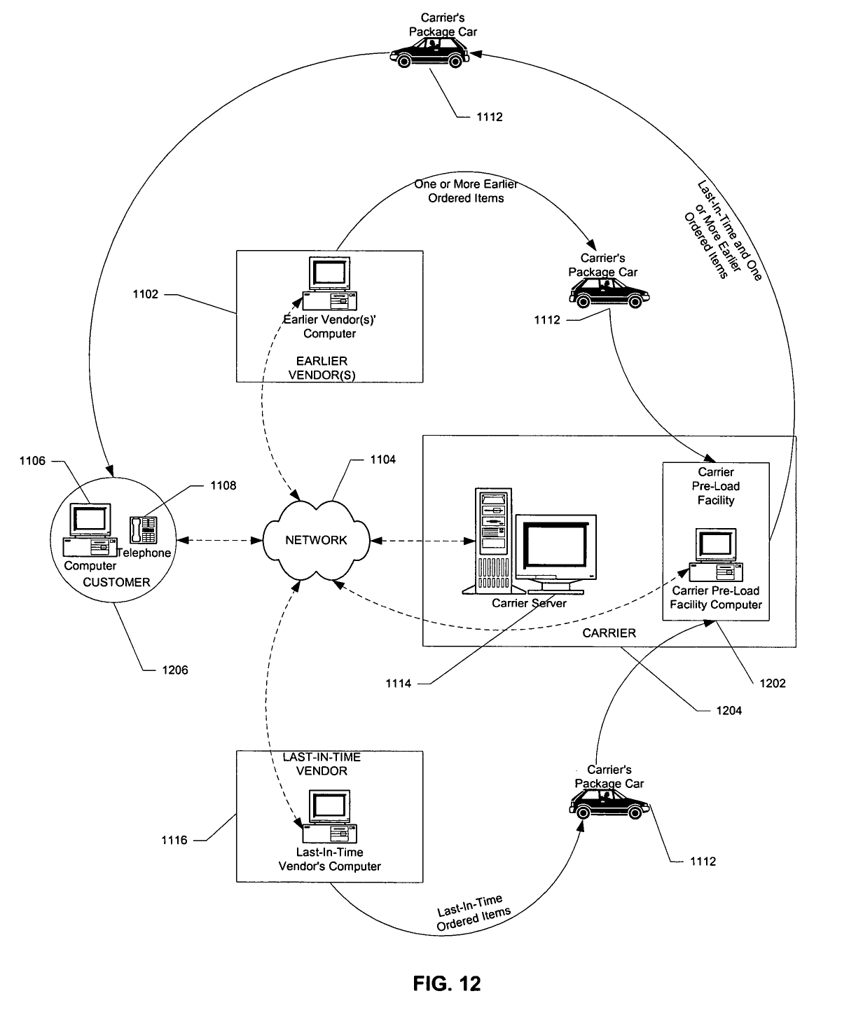

FIG. 12 is a system for substantially simultaneously delivering a plurality of packages containing items that have been ordered in separate orders from one or more vendors to a customer that has ordered the items. The embodiment of FIG. 12 is similar to that of FIG. 11; however, the embodiment of FIG. 11 is further comprised of a carrier's pre-load facility 1202. The pre-load facility 1202 allows the carrier 1204 to delay the delivery of the one or more earlier orders or the Last-In-Time Order so that the orders may be aggregated into a single delivery to the customer 1206 by the carrier 1204. For instance, if the customer 1206 wants to aggregate the Last-In-Time Order with one or more earlier orders, the customer 1206 authorizes the carrier 1204 to issue a merge/sort order to the pre-load facility 1202 so that the items that comprise the one or more earlier orders will be held at the pre-load facility 1202 until they can be aggregated with the items that comprise the Last-In-Time Order for a substantially simultaneous delivery to the customer 1206. In one embodiment the merge/hold instruction electronically links through the use of computers the package tracking information of the items that comprise the earlier orders with the package tracking information of the items that comprise the Last-In-Time Order so that the items that arrive earliest at the pre-load facility 1202 are held until all the linked items are received and form a single delivery to the customer 1206.

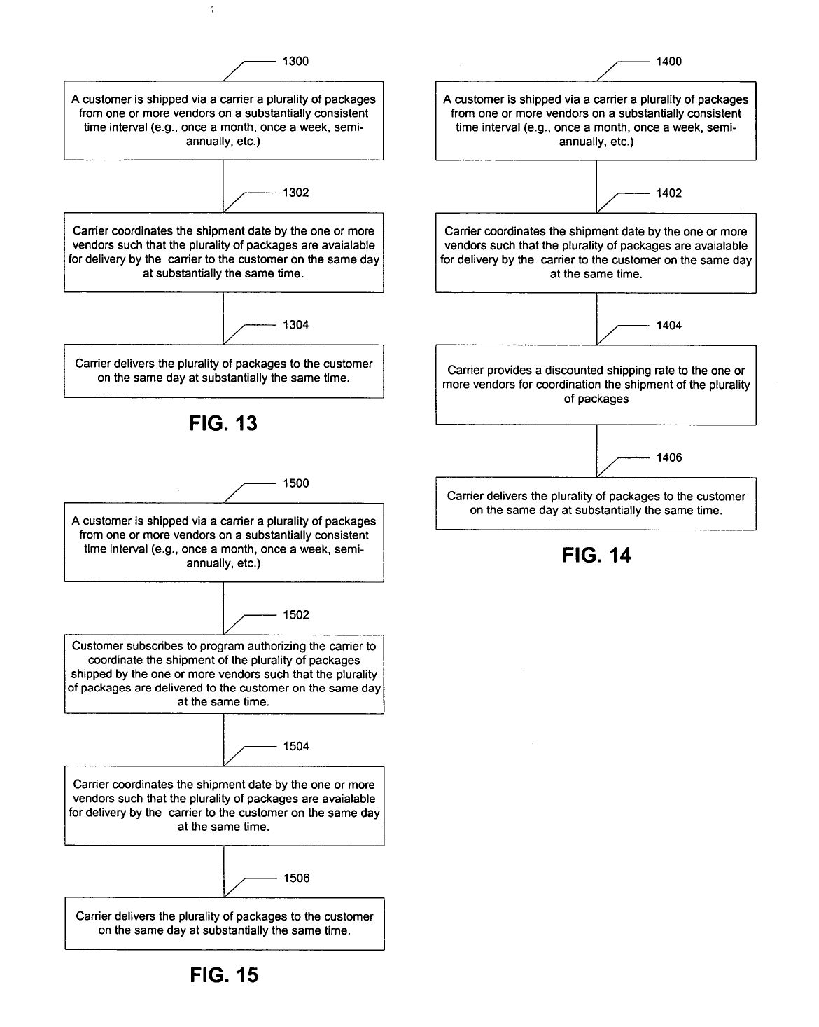

FIG. 13 is a flowchart that describes the steps for aggregating multiple packages for a single delivery to a customer, in an embodiment of the invention, wherein the packages are shipped on a substantially consistent basis and a carrier coordinates the shippers' shipment date. The process begins at Step 1300 where a customer is shipped via a carrier a plurality of packages from one or more shippers on a substantially consistent time interval such as, for example, weekly, monthly, twice monthly, semi-annually, etc. The shippers may be, for example, vendors that ship collectibles to subscribing collectors on a substantially consistent basis, vendors that ship a gift product on a substantially consistent time interval such as, for example, book of the month, fruit of the month, wine of the month, jelly of the month, etc. The carrier may be, for example, UPS, FedEx, RPS, DHL, etc. At Step 1302, the carrier coordinates with the one or more shippers the shipment date of shipments to a certain customer such that the plurality of packages are available for delivery by the carrier to the customer at substantially the same time. For instance, a wine of the month shipper in California may ship their package(s) on the second day of the month via ground transportation of the carrier with the knowledge that it will take three days to reach a customer in Georgia and a cheese of the month shipper in Wisconsin may ship their package(s) to the same Georgia customer on the fourth day of the month via next day air such that the wine and cheese are delivered to the Georgia customer via the same package car at substantially the same time.

At Step 1304, the carrier delivers the plurality of packages to the customer on the same day and substantially at the same time and, in the above example, the customer can enjoy the wine and cheese together.

FIG. 14 is another flowchart that describes the steps for aggregating multiple packages for a single delivery to a customer, in an embodiment of the invention, wherein the packages are shipped on a substantially consistent basis and a carrier coordinates the shippers' shipment date. The embodiment of FIG. 14 is similar to the embodiment shown in FIG. 13; however, as provided in Step 1404, in FIG. 14 the shippers receive a discounted shipping rate from the carrier for allowing the carrier to coordinate their shipments.

The process begins at Step 1400 where a customer is shipped via a carrier a plurality of packages from one or more shippers on a substantially consistent time interval such as, for example, weekly, monthly, twice monthly, semi-annually, etc. At Step 1402, the carrier coordinates with the one or more shippers the shipment date of shipments to a certain customer such that the plurality of packages are available for delivery by the carrier to the customer at substantially the same time. At Step 1404, the carrier provides a discounted shipping rate to the one or more shippers for allowing the carrier to coordinate (e.g. designate the date of shipment and class of service) the shipment of the plurality of packages. At Step 1406, the carrier delivers the plurality of packages to the customer on the same day and substantially at the same time, thus ending the process.

FIG. 15 is another flowchart that describes the steps for aggregating multiple packages for a single delivery to a customer, in an embodiment of the invention, wherein the packages are shipped on a substantially consistent basis and a carrier coordinates the shippers' shipment date. The embodiment of FIG. 15 is a variant of the embodiments described in FIGS. 13 and 14. The flowchart of FIG. 15 includes the step of the customer subscribing to a program that authorizes the carrier to coordinate the shipment of the plurality of packages shipped by the one or more shippers such that the packages are delivered to the customer at substantially the same time.

The process begins at Step 1500 where a customer is shipped via a carrier a plurality of packages from one or more shippers on a substantially consistent time interval such as, for example, weekly, monthly, twice monthly, semi-annually, etc. At Step 1502, the customer subscribes to a program offered by the carrier that authorizes the carrier to coordinate the shipment of the plurality of packages shipped by the one or more shippers to the customer on a substantially consistent basis such that the packages are delivered to the customer at substantially the same time. At Step 1504, the carrier coordinates with the one or more shippers the shipment date of shipments to a certain customer such that the plurality of packages are available for delivery by the carrier to the customer at substantially the same time. At Step 1506, the carrier delivers the plurality of packages to the customer on the same day and substantially at the same time, thus ending the process.

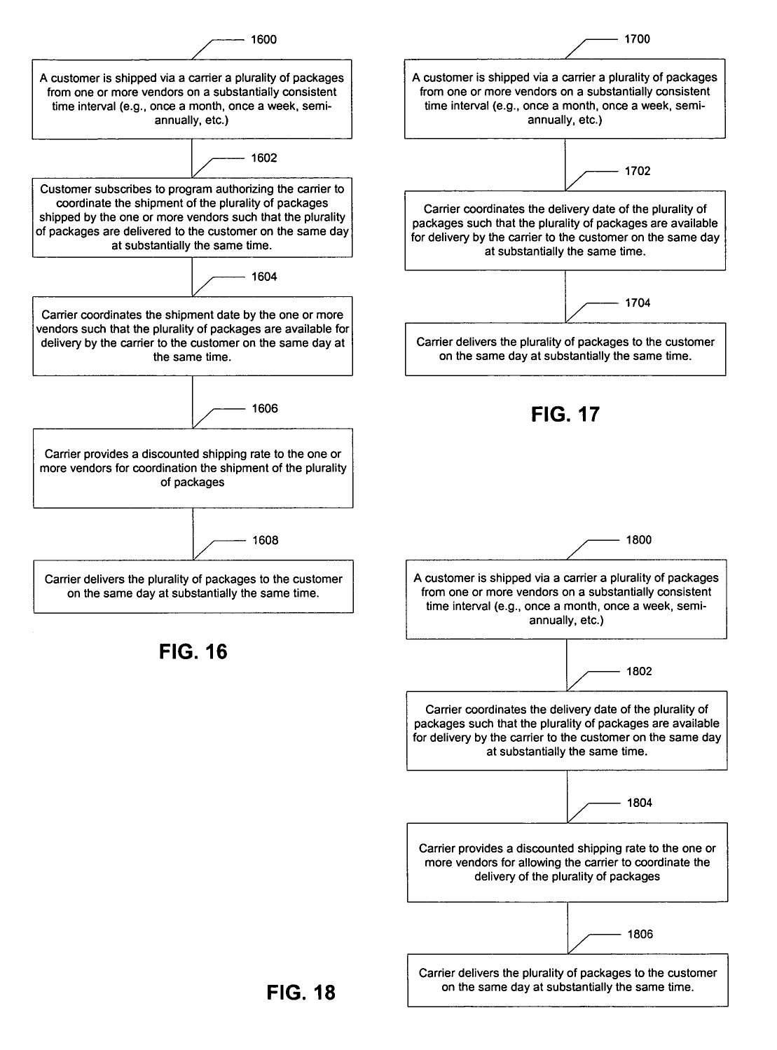

FIG. 16 is another flowchart that describes the steps for aggregating multiple packages for a single delivery to a customer, in an embodiment of the invention, wherein the packages are shipped on a substantially consistent basis and a carrier coordinates the shippers' shipment date. The embodiment of FIG. 16 is a variant of the embodiments described in FIGS. 13, 14 and 15. The process begins at Step 1600 where a customer is shipped via a carrier a plurality of packages from one or more shippers on a substantially consistent time interval such as, for example, weekly, monthly, twice monthly, semi-annually, etc. At Step 1602, the customer subscribes to a program offered by the carrier that authorizes the carrier to coordinate the shipment of the plurality of packages shipped by the one or more shippers to the customer on a substantially consistent basis such that the packages are delivered to the customer at substantially the same time. At Step 1604, the carrier coordinates with the one or more shippers the shipment date of shipments to a certain customer such that the plurality of packages are available for delivery by the carrier to the customer at substantially the same time. At Step 1606, the carrier provides a discounted shipping rate to the one or more shippers for allowing the carrier to coordinate (e.g. designate the date of shipment and class of service) the shipment of the plurality of packages. At Step 1608, the carrier delivers the plurality of packages to the customer on the same day and substantially at the same time, thus ending the process.

FIG. 17 is a flowchart that describes the steps for aggregating multiple packages for a single delivery to a customer, in an embodiment of the invention, wherein the packages are shipped on a substantially consistent basis and a carrier coordinates the delivery date of the packages. The process begins at Step 1700 where a customer is shipped via a carrier a plurality of packages from one or more shippers on a substantially consistent time interval such as, for example, weekly, monthly, twice monthly, semi-annually, etc. At Step 1702, the carrier coordinates the delivery date of a plurality of shipments to a certain customer by merging, holding or accelerating shipments from the one or more shippers such that they can be combined with other shipments to the same customer and delivered substantially simultaneously. At Step 1704, the carrier delivers the plurality of packages to the customer on the same day and substantially at the same time, thus ending the process of FIG. 17.

FIG. 18 is a flowchart that describes the steps for aggregating multiple packages for a single delivery to a customer, in an embodiment of the invention, wherein the packages are shipped on a substantially consistent basis and a carrier coordinates the delivery date of the packages. The process begins at Step 1800 where a customer is shipped via a carrier a plurality of packages from one or more shippers on a substantially consistent time interval such as, for example, weekly, monthly, twice monthly, semi-annually, etc. At Step 1802, the carrier coordinates the delivery date of a plurality of shipments to a certain customer by merging, holding or accelerating shipments from the one or more shippers such that they can be combined with other shipments to the same customer and delivered substantially simultaneously. At Step 1804, the carrier provides a discounted shipping rate to the one or more shippers for allowing the carrier to coordinate (e.g. designate the date of shipment and class of service) the delivery of the plurality of packages. At Step 1806, the carrier delivers the plurality of packages to the customer on the same day and substantially at the same time, thus ending the process of FIG. 18.

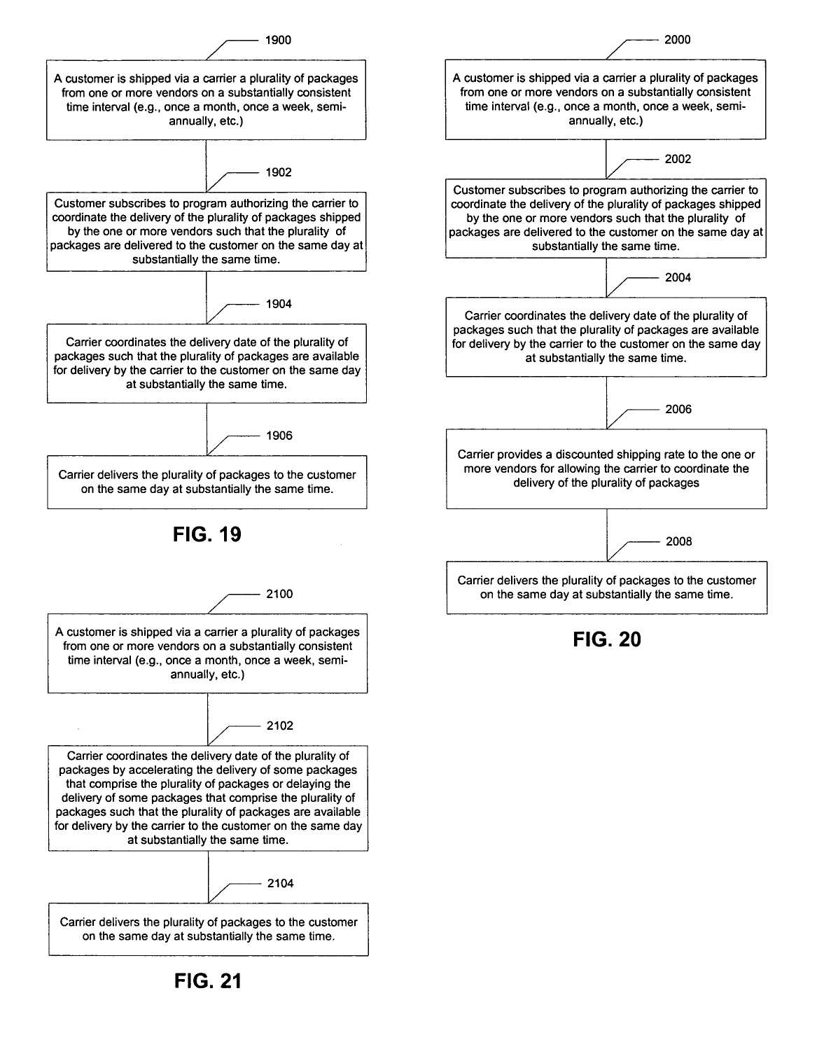

FIG. 19 is a flowchart that describes the steps for aggregating multiple packages for a single delivery to a customer, in an embodiment of the invention, wherein the packages are shipped on a substantially consistent basis and a carrier coordinates the delivery date of the packages. The process begins at Step 1900 where a customer is shipped via a carrier a plurality of packages from one or more shippers on a substantially consistent time interval such as, for example, weekly, monthly, twice monthly, semi-annually, etc. At Step 1902, the customer subscribes to a program provided by the carrier that authorizes the carrier to coordinate the delivery of the plurality of packages shipped by the one or more shippers such that the plurality of packages are available for delivery by the carrier to the customer on the same day at substantially the same time. At Step 1904, the carrier coordinates the delivery date of a plurality of shipments to a certain customer by merging, holding or accelerating shipments from the one or more shippers such that they can be combined with other shipments to the same customer and delivered substantially simultaneously. At Step 1906, the carrier delivers the plurality of packages to the customer on the same day and substantially at the same time, thus ending the process of FIG. 19.

FIG. 20 is a flowchart that describes the steps for aggregating multiple packages for a single delivery to a customer, in an embodiment of the invention, wherein the packages are shipped on a substantially consistent basis and a carrier coordinates the delivery date of the packages. The process begins at Step 2000 where a customer is shipped via a carrier a plurality of packages from one or more shippers on a substantially consistent time interval such as, for example, weekly, monthly, twice monthly, semi-annually, etc. At Step 2002, the customer subscribes to a program provided by the carrier that authorizes the carrier to coordinate the delivery of the plurality of packages shipped by the one or more shippers such that the plurality of packages are available for delivery by the carrier to the customer on the same day at substantially the same time. At Step 2004, the carrier coordinates the delivery date of a plurality of shipments to a certain customer by merging, holding or accelerating shipments from the one or more shippers such that they can be combined with other shipments to the same customer and delivered substantially simultaneously. At Step 2006, the carrier provides a discounted shipping rate to the one or more shippers for allowing the carrier to coordinate (e.g. designate the date of shipment and class of service) the delivery of the plurality of packages. At Step 2008, the carrier delivers the plurality of packages to the customer on the same day and substantially at the same time, thus ending the process of FIG. 20.

FIG. 21 is a flowchart that describes the steps for aggregating multiple packages for a single delivery to a customer, in an embodiment of the invention, wherein the packages are shipped on a substantially consistent basis and a carrier coordinates the delivery date of the packages. The process begins at Step 2100 where a customer is shipped via a carrier a plurality of packages from one or more shippers on a substantially consistent time interval such as, for example, weekly, monthly, twice monthly, semi-annually, etc. At Step 2102, the carrier coordinates the delivery date of a plurality of shipments to a certain customer by accelerating the delivery of some packages that comprise the plurality of packages or delaying the delivery of some packages that comprise the plurality of packages such that the plurality of packages are available for delivery by the carrier to the customer on the same day and at substantially the same time. At Step 2104, the carrier delivers the plurality of packages to the customer on the same day and substantially at the same time, thus ending the process of FIG. 21.

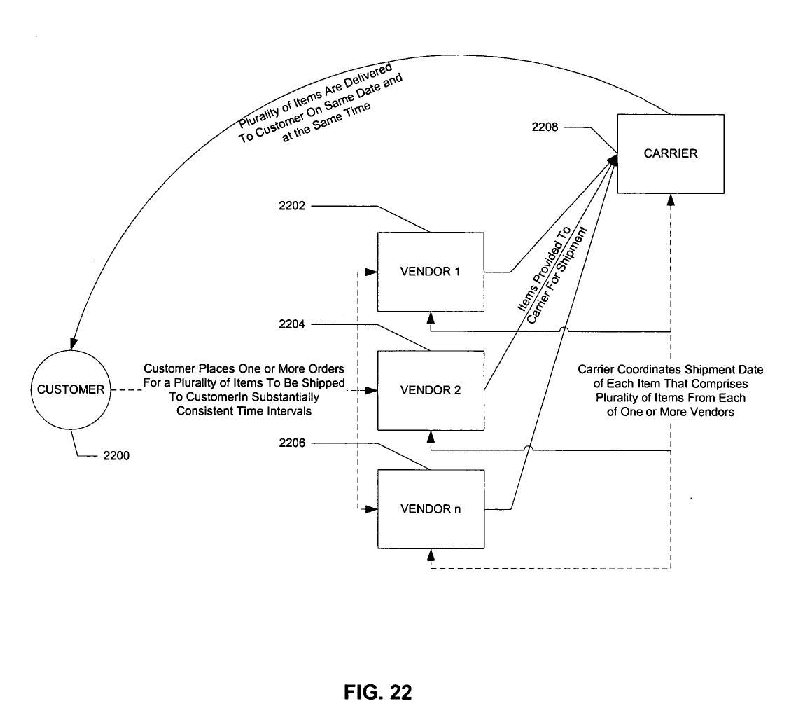

FIG. 22 is a diagrammatic representation of the components of a system for implementing an embodiment of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system. A customer 2200 places orders with one or more vendors 2202, 2204, 2206 for products that will be shipped to the customer 2200 on a substantially consistent time basis (e.g., once a month, once a week, etc.) The carrier 2208 will coordinate the shipment date of each one or more vendor's 2202, 2204, 2206 shipment to the customer such that the ordered items may be provided to that carrier 2208 at different dates or different classes of service; however, the shipment date and service class is organized by the carrier 2208 such that the ordered items arrive at the customer's location at substantially the same time, as delivered by the carrier 2208.

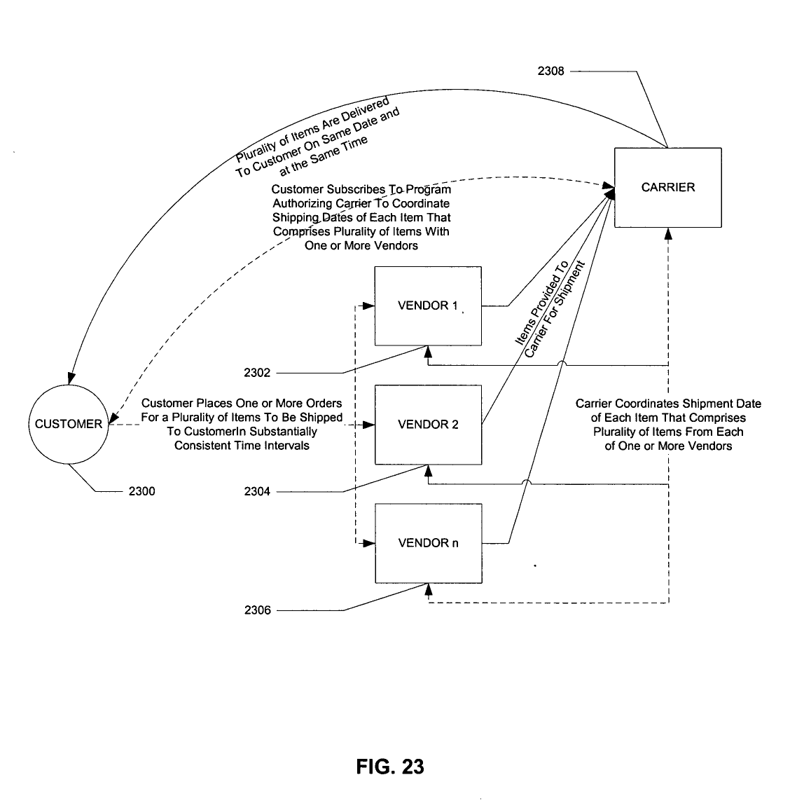

FIG. 23 is a diagrammatic representation of the components of a system for implementing an embodiment of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system. A customer 2300 places orders with one or more vendors 2302, 2304, 2306 for products that will be shipped to the customer 2300 on a substantially consistent time basis (e.g., once a month, once a week, etc.) The customer 2300 subscribes to a carrier-offered program that authorizes the carrier 2308 to coordinate the shipping dates and the class of service of each shipment to the customer 2300 by each of one or more vendors 2302, 2304, 2306 such that the shipments will be delivered to the customer 2300 by the carrier 2308 at substantially the same time. The carrier 2308 coordinates the shipment date of each one or more vendor's 2302, 2304, 2306 shipment to the customer such that the ordered items may be provided to that carrier 2308 at different dates or different classes of service; however, the shipment date and service class is organized by the carrier 2308 such that the ordered items arrive at the customer's location at substantially the same time, as delivered by the carrier 2308.

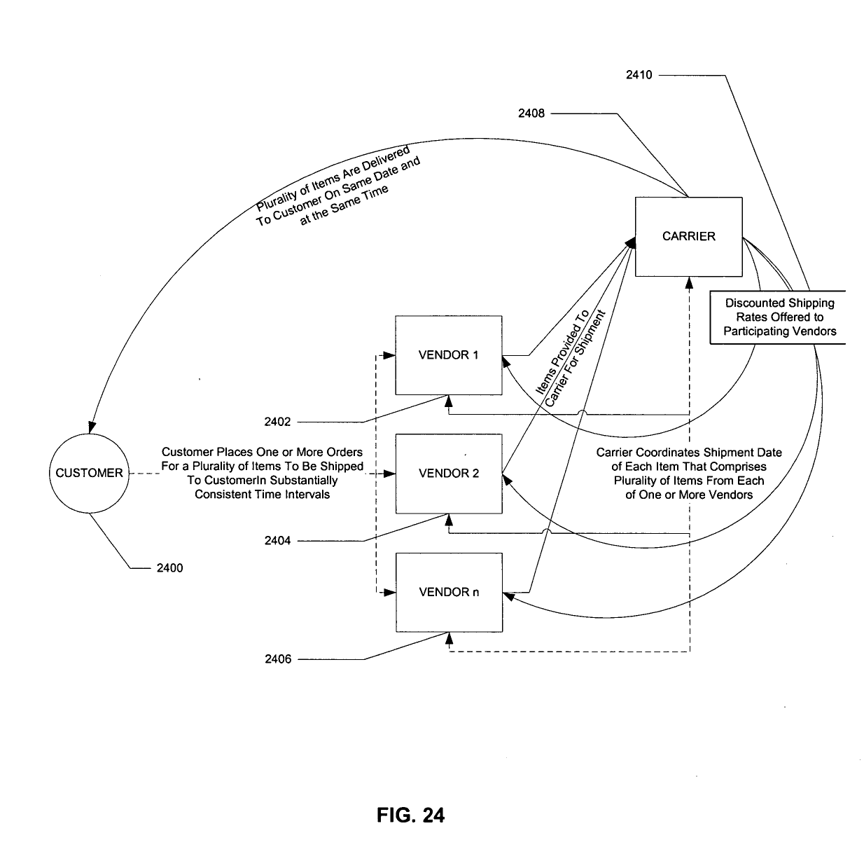

FIG. 24 is a diagrammatic representation of the components of a system for implementing an embodiment of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system. A customer 2400 places orders with one or more vendors 2402, 2404, 2406 for products that will be shipped to the customer 2400 on a substantially consistent time basis (e.g., once a month, once a week, etc.) The carrier 2408 coordinates the shipment date of each one or more vendor's 2402, 2404, 2406 shipment to the customer such that the ordered items may be provided to that carrier 2408 at different dates or different classes of service; however, the shipment date and service class is organized by the carrier 2408 for each shipment such that the ordered items arrive at the customer's location at substantially the same time, as delivered by the carrier 2408. In this embodiment, the carrier 2408 provides discounted shipping rates 2410 to the one or more vendors 2402, 2404, 2406 for allowing the carrier to coordinate the shipping dates are service class of the vendors' shipments.

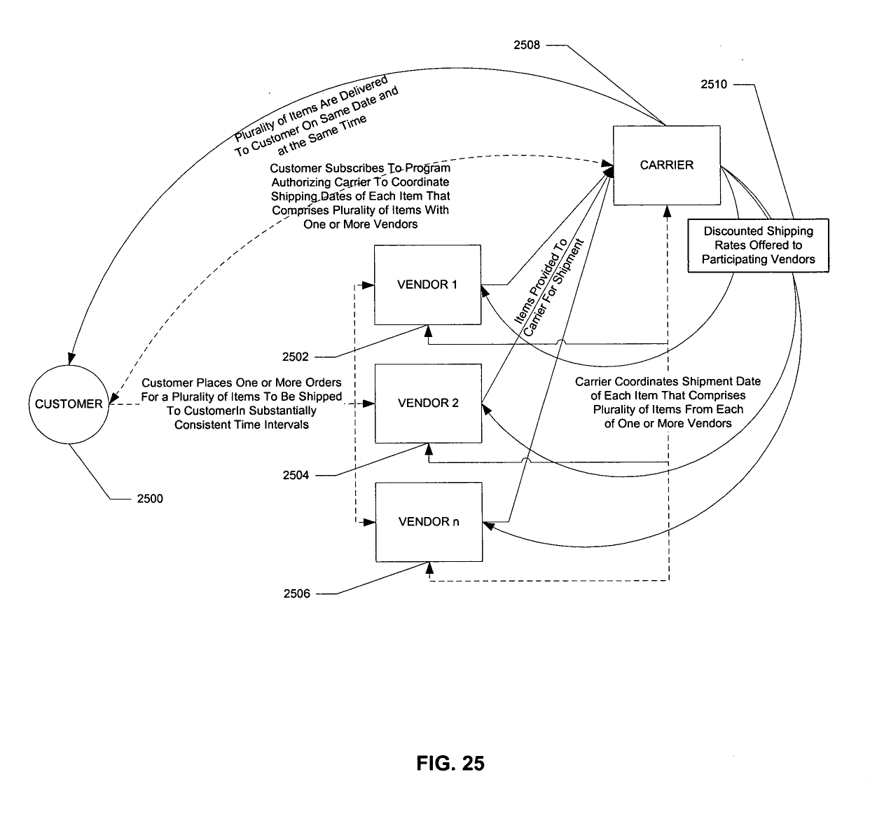

FIG. 25 is a diagrammatic representation of the components of a system for implementing an embodiment of the invention, wherein a carrier coordinates the shipment date of one or more shippers (e.g., vendors) having substantially consistent shipments to a customer such that the shipments are delivered to the customer by that carrier at substantially the same time, and the interrelationship between the various components of the system. A customer 2500 places orders with one or more vendors 2502, 2504, 2506 for products that will be shipped to the customer 2500 on a substantially consistent time basis (e.g., once a month, once a week, etc.) The customer 2500 subscribes to a carrier-offered program that authorizes the carrier 2508 to coordinate the shipping dates and the class of service of each shipment to the customer 2500 by each of one or more vendors 2502, 2504, 2506 such that the shipments will be delivered to the customer 2500 by the carrier 2508 at substantially the same time. The carrier 2508 coordinates the shipment date of each one or more vendor's 2502, 2504, 2506 shipment to the customer such that the ordered items may be provided to that carrier 2508 at different dates or different classes of service; however, the shipment date and service class is organized by the carrier 2508 for each shipment such that the ordered items arrive at the customer's location at substantially the same time, as delivered by the carrier 2508. In this embodiment of FIG. 25, the carrier 2508 provides discounted shipping rates 2510 to the one or more vendors 2502, 2504, 2506 for allowing the carrier to coordinate the shipping dates are service class of the vendors' shipments.

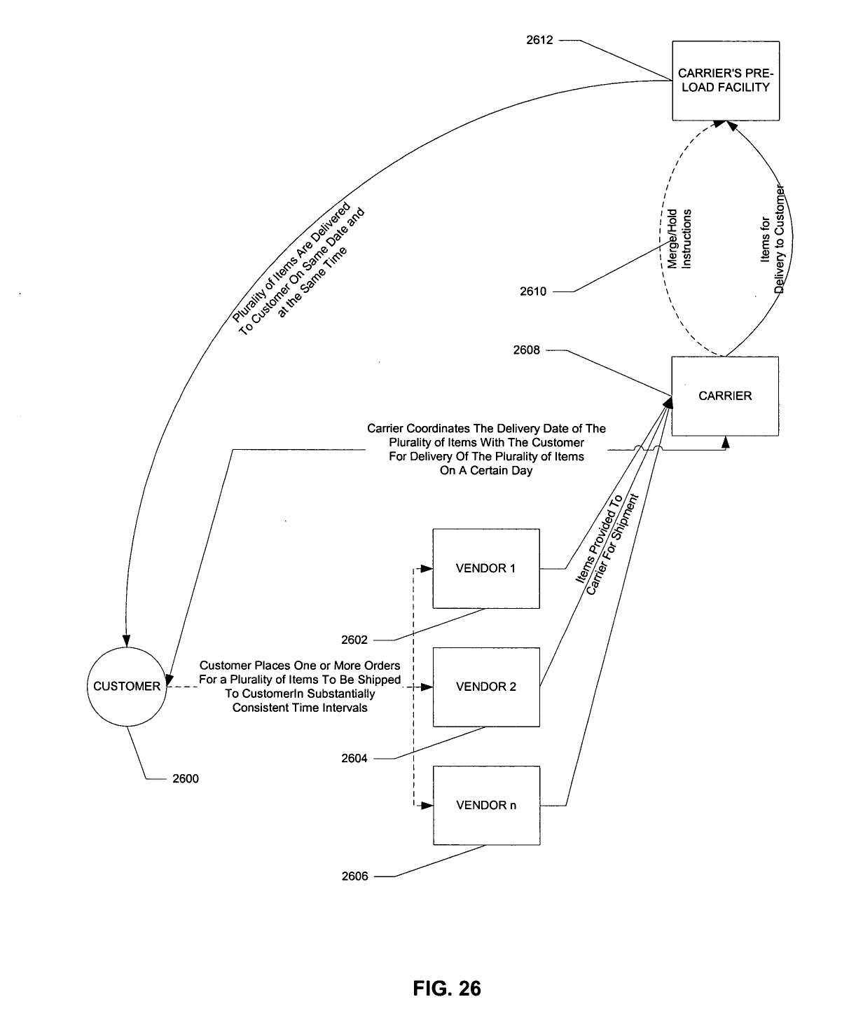

FIG. 26 is a diagrammatic representation of the components of a system for implementing an embodiment of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system. A customer 2600 places orders with one or more vendors 2602, 2604, 2606 for products that will be shipped to the customer 2600 on a substantially consistent time basis (e.g., once a month, once a week, etc.) The carrier 2608 coordinates the delivery date of each one or more vendor's 2602, 2604, 2606 shipment to the customer such that the ordered items may be provided to that carrier 2608 at different dates and/or different classes of service; however, the delivery date is organized by the carrier 2608 for all shipments to the customer 2600 such that the ordered items arrive at the customer's location at substantially the same time, as delivered by the carrier 2508. For instance, the carrier 2608 may issue a merge/hold order 2610 to a carrier pre-load facility 2612 so that multiple shipments to one customer are merged into one shipment. In order to provide this service, some shipments may be held at the pre-load facility 2612 until other shipments arrive, or the shipment of later-shipped items may be accelerated so that they can be combined with other shipments. This process is coordinated by the carrier 2608 such that the number of actual deliveries to the customer 2600 are minimized.

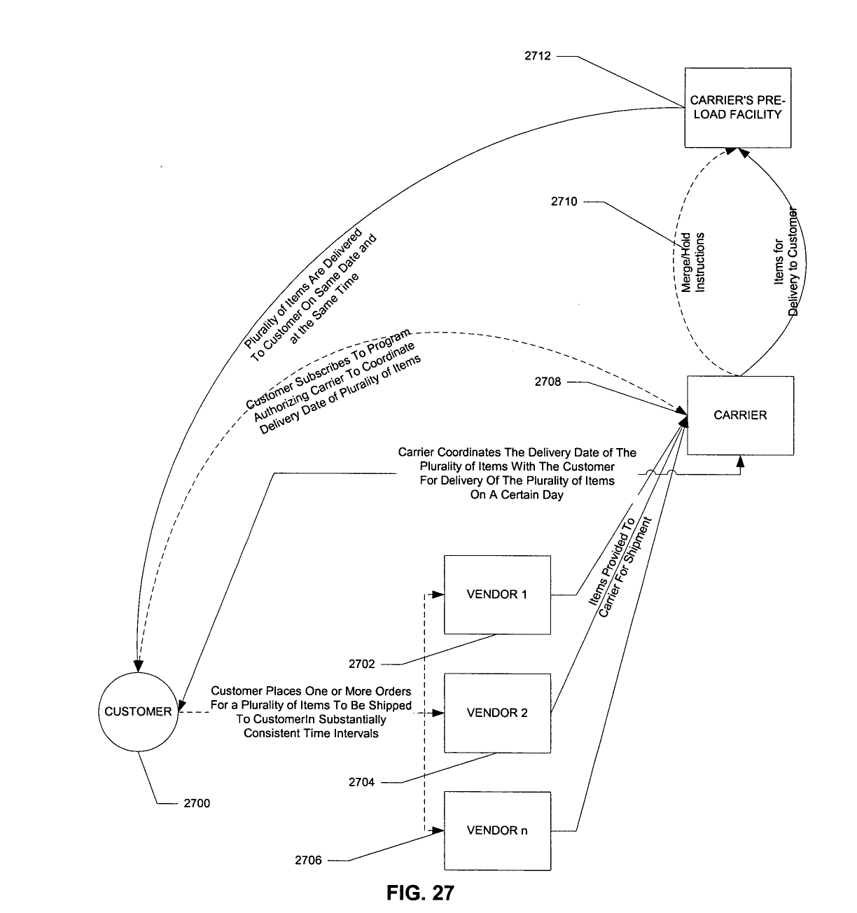

FIG. 27 is a diagrammatic representation of the components of a system for implementing an embodiment of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system. A customer 2700 places orders with one or more vendors 2702, 2704, 2706 for products that will be shipped to the customer 2700 on a substantially consistent time basis (e.g., once a month, once a week, etc.) The customer 2700 subscribes to a program that authorizes the carrier 2708 to coordinate the delivery of the plurality of shipments. The carrier 2708 coordinates the delivery date of each one or more vendor's 2702, 2704, 2706 shipment to the customer such that the ordered items may be provided to that carrier 2708 at different dates and/or different classes of service; however, the delivery date is organized by the carrier 2708 for all shipments to the customer 2700 such that the ordered items arrive at the customer's location at substantially the same time, as delivered by the carrier 2708. For instance, the carrier 2708 may issue a merge/hold order 2710 to a carrier pre-load facility 2712 so that multiple shipments to one customer are merged into one shipment. In order to provide this service, some shipments may be held at the pre-load facility 2712 until other shipments arrive, or the shipment of later-shipped items may be accelerated so that they can be combined with other shipments. This process is coordinated by the carrier 2708 such that the number of actual deliveries to the customer 2700 are minimized.

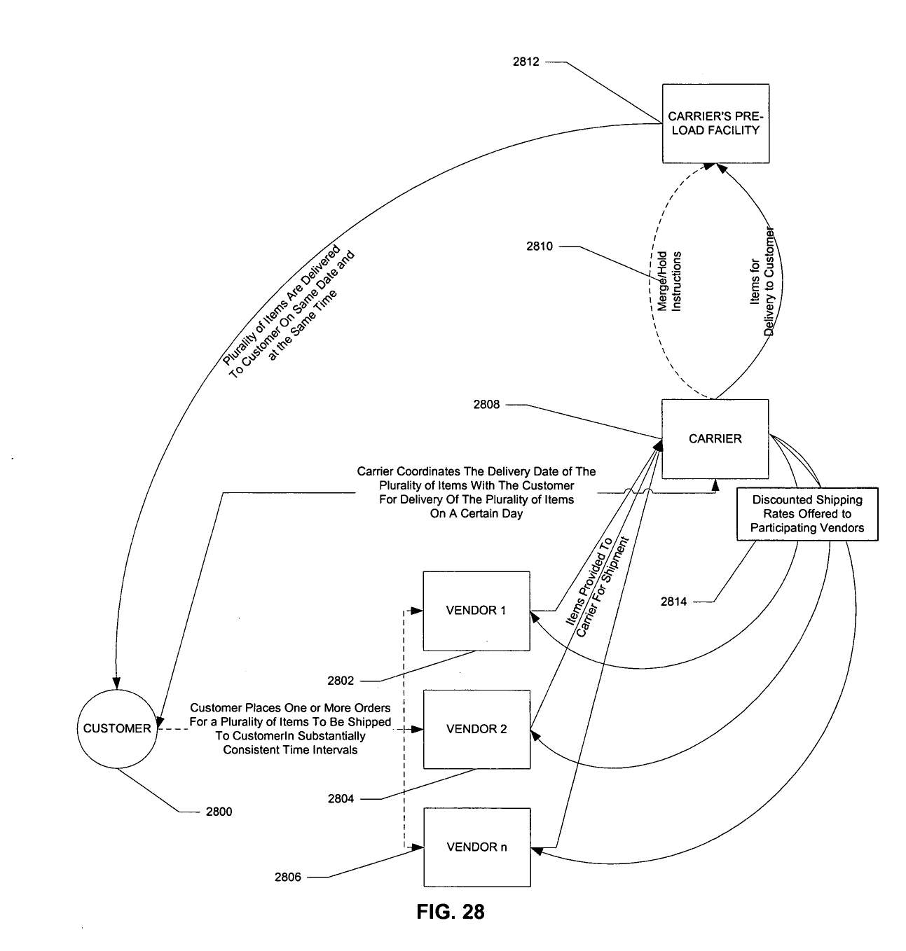

FIG. 28 is a diagrammatic representation of the components of a system for implementing an embodiment of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system. A customer 2800 places orders with one or more vendors 2802, 2804, 2806 for products that will be shipped to the customer 2800 on a substantially consistent time basis (e.g., once a month, once a week, etc.) The carrier 2808 coordinates the delivery date of each one or more vendor's 2802, 2804, 2806 shipment to the customer such that the ordered items may be provided to that carrier 2808 at different dates and/or different classes of service; however, the delivery date is organized by the carrier 2808 for all shipments to the customer 2800 such that the ordered items arrive at the customer's location at substantially the same time, as delivered by the carrier 2808. For instance, the carrier 2808 may issue a merge/hold order 2810 to a carrier pre-load facility 2812 so that multiple shipments to one customer are merged into one shipment. In order to provide this service, some shipments may be held at the pre-load facility 2812 until other shipments arrive, or the shipment of later-shipped items may be accelerated so that they can be combined with other shipments. The process is managed by the carrier 2808 such that the number of actual deliveries to the customer 2800 are minimized. In the embodiment of FIG. 28, the shippers 2802, 2804, 2806 are provided a shipping discount 2814 for allowing the carrier 2808 to manage the delivery of the vendors' shipments.

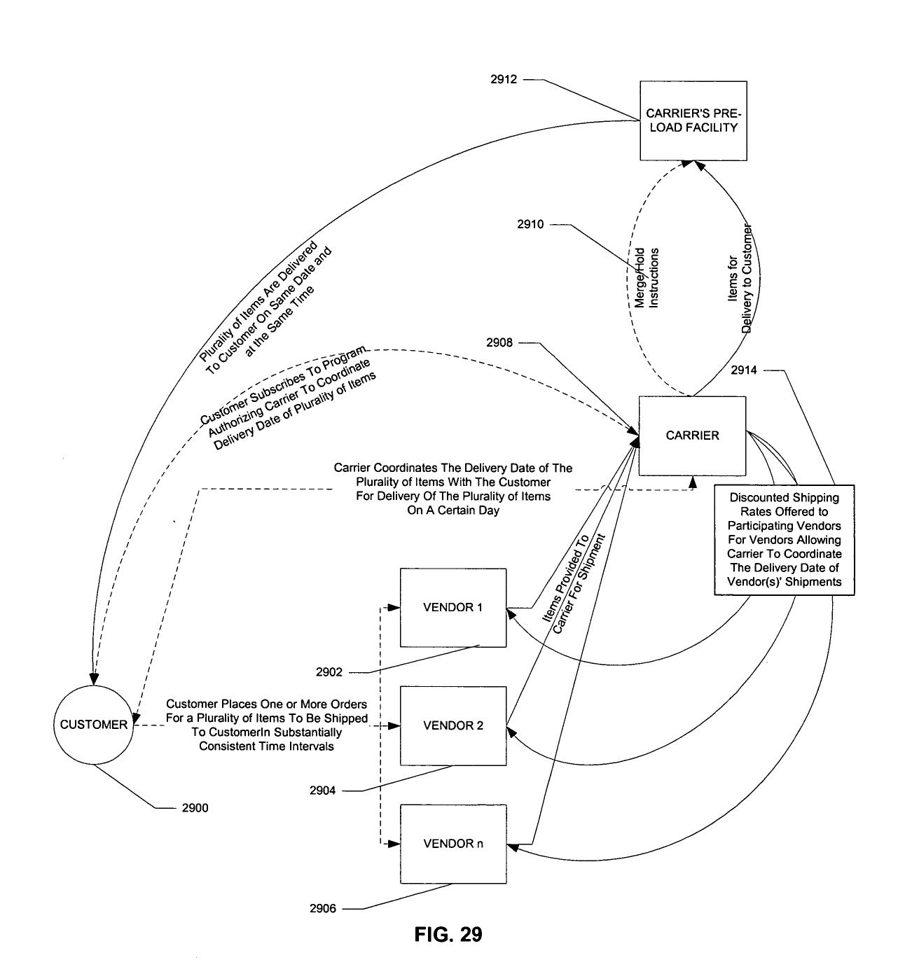

FIG. 29 is a diagrammatic representation of the components of a system for implementing an embodiment of the invention, wherein a carrier coordinates the delivery date of a plurality of items shipped by one or more shippers (e.g., vendors) having substantially consistent shipments to a customer such that the shipments are delivered to the customer by that carrier at substantially the same time, and the interrelationship between the various components of the system. A customer 2900 places orders with one or more vendors 2902, 2904, 2906 for products that will be shipped to the customer 2900 on a substantially consistent time basis (e.g., once a month, once a week, etc.) The customer 2900 subscribes to a program that authorizes the carrier 2908 to manage the delivery date of a plurality of items shipped by the one or more vendors 2902, 2904, 2906. The carrier 2908 coordinates the delivery date of each one or more vendor's 2902, 2904, 2906 shipment to the customer such that the ordered items may be provided to that carrier 2908 at different dates and/or different classes of service; however, the delivery date is organized by the carrier 2908 for all shipments to the customer 2900 such that the ordered items arrive at the customer's location at substantially the same time, as delivered by the carrier 2908. For instance, the carrier 2908 may issue a merge/hold order 2910 to a carrier pre-load facility 2912 so that multiple shipments to one customer are merged into one shipment. In order to provide this service, some shipments may be held at the pre-load facility 2912 until other shipments arrive, or the shipment of later-shipped items may be accelerated so that they can be combined with other shipments. The process is managed by the carrier 2908 such that the number of actual deliveries to the customer 2900 are minimized. In the embodiment of FIG. 29, the shippers 2902, 2904, 2906 are provided a shipping discount 2914 for allowing the carrier 2908 to manage the delivery of the vendors' shipments.

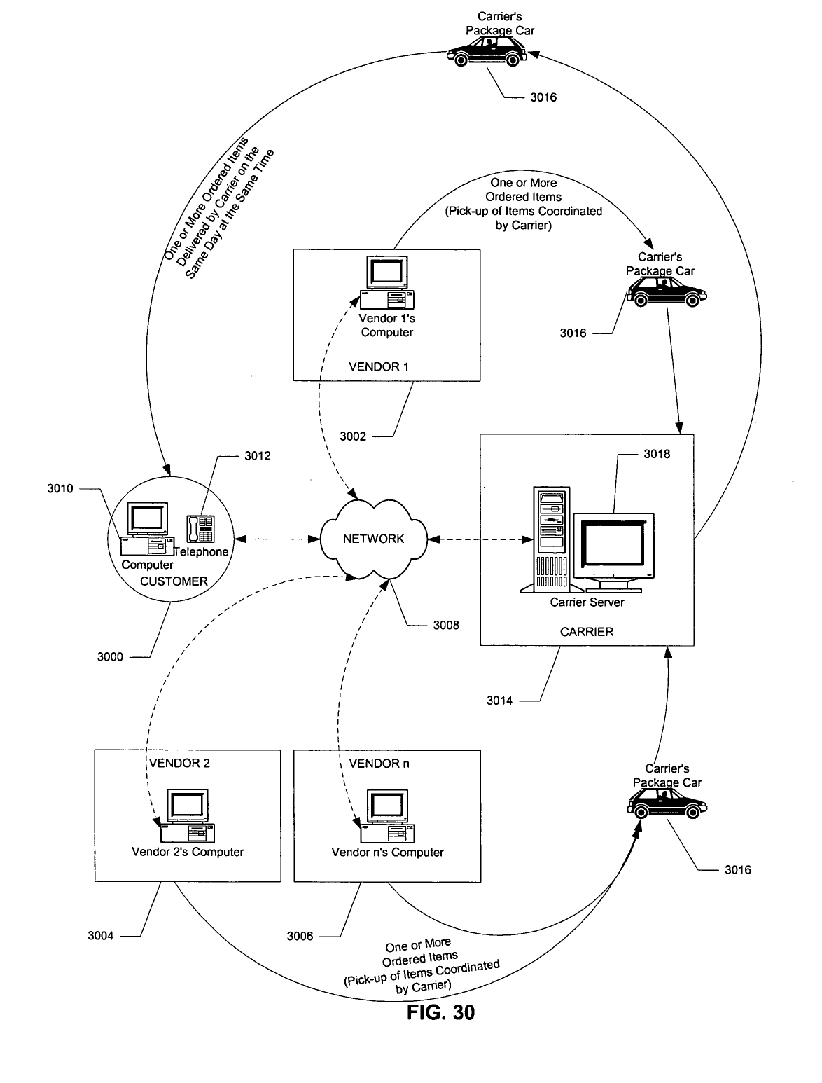

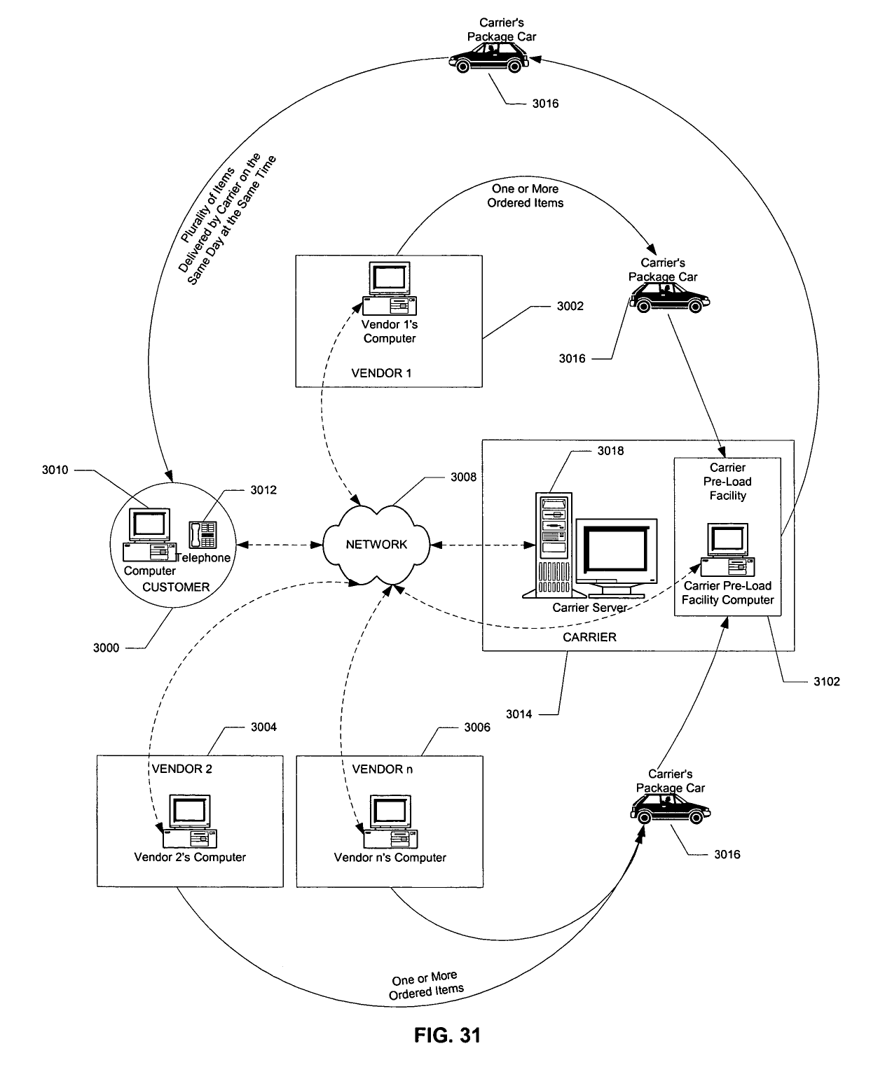

FIG. 30 is a system for substantially simultaneously delivering a plurality of packages containing items that have been ordered in separate orders from one or more vendors to a customer that has ordered the items. The system shown in FIG. 30 may be used to implement various embodiments of the methods described herein. In FIG. 30, a customer 3000 places one or more orders with one or more vendors 3002, 3004, 3006. The orders may be placed over a network 3008 such as, for example, the Internet by use of a computer or interface device 3010, or a telephone system by use of a telephone device 3012, by combinations thereof, or by any other means of communicating over a network 3008. Also, orders may be placed by the customer 3000 while at vendors' facilities, or by any other means by which orders may be placed.

The network 3008 may be wired, wireless, optical or any combination thereof. The network 3008 may utilize the Internet, direct connection, electronic data exchange, local area networking, wide area networking, digital, analog, combinations of any of these elements, etc.

Once the one or more vendors 3002, 3004, 3006 have received one or more orders from the customer 3000, the one or more vendors 3002, 3004, 3006 will then prepare the customer's order for shipment and will contact a carrier 3014 to make a shipping request, or one or more of the vendors 3002, 3004, 3006 will have a pre-existing business arrangement with the carrier 3014 for the shipment of the vendor's packages. The items that comprise the one or more orders are then presented to the carrier 3014 for shipping. Generally, the carrier 3014 picks up the items to be shipped by use of a package car 3016, as shown in FIG. 30. In other embodiments, the items to be shipped may be dropped off to the carrier 3014.

Once the one or more ordered items are received by the carrier 3014 for shipping, information about each package is maintained by the carrier 3014. This information is generally stored in a computer controlled by the carrier 3014, such as a carrier server 3018. Information about each package includes a package tracking identifier such as a package tracking number that uniquely identifies each package being shipped. In the embodiments of FIG. 30, the vendors 3002, 3004, 3006 provide the customer 3000 with the package tracking information of each package that comprises the orders. This information is generally provided over the network 3008, though it may be provided by other means such as orally or in writing.

The customer 3000 may then place one or more additional orders with one or more vendors 3002, 3004, 3006. Once each order is placed, the customer will received package tracking information for that order from the vendor with whom the order is placed, as such information is provided to the vendor by the carrier 3014. The customer 3000 may also provide the vendor with package tracking information about other packages from earlier orders that the customer 3000 would like merged into one order by the carrier 3014 and delivered to the customer 3000 substantially simultaneously. This may be performed by entering certain package identifying information in a field at the vendor's website, keying in information over a touch-tone phone system, using an interactive voice recognition system, providing the information to a representative of the vendor, etc. The vendor, upon receiving this merge information, will pass the merge information on to the carrier 3014. The carrier 3014 will then note the merge instructions in the package information stored on the carrier server 3018 for each package that is intended for the customer 3000 and which the customer 3000 has indicated the desire to have the packages delivered at substantially the same time by the carrier 3014.

In one embodiment, the customer may provide a discount to the shipper(s) 3002, 3004, 3006 for allowing the delivery of the vendor's shipment to be managed and possibly delayed by the carrier 3014. The vendor may choose to pass some or all of the discount to the customer 3000. In the embodiment of FIG. 30, if there is more than one order, the carrier 3014 may want to determine whether any of the other orders have already received a discount for aggregated delivery. This may be accomplished by flagging or otherwise indicating in the package level detail information stored in the carrier's databases (on the carrier server 3018) about each package shipped that the packages that comprise one of the other orders have received a discount or have been combined with one or more other orders for delivery. In this manner, the carrier 3014 may provide progressive discounts when multiple (more than two) orders are delivered simultaneously, and such flagging also helps prevent circumventing the system. For instance, if the customer 3000 has just made a second order, then in accordance with the embodiments described above (when there are only first and second orders), the second order may be eligible for a shipping discount. If the customer 3000 then places a third order and makes the third vendor aware of the shipping information of the first two orders, then the customer 3000 may be eligible for a graduated shipping discount on the third order, or the customer 3000 may not be eligible for a discount since the customer received a discount on the second order. In either circumstance, however, by flagging packages that have received discounts for aggregated delivery in the carrier's package level information, the carrier 3014 is able to determine if additional orders shipped to the customer 3000 are eligible for discounted shipping and, if so, how much discount. The “flag” used in the carrier's databases may be coded in one embodiment so that the carrier 3014 can determine if the discount provided to the packages was for aggregating the order with one other order, two other orders, three other orders, etc. In the manner described above, the carrier 3014 can provide discounts (or not provide any discount) for multiple orders (more than two) delivered substantially simultaneously to the same customer 3000.

Once information about any earlier orders is received by vendor 3002, 3004, 3006, the vendor may keep any discounts offered by the carrier 3014 or the vendor may share or pass all the benefits to the customer 3000. In one embodiment, if the vendor(s) of earlier orders have had the delivery of their shipments delayed by the carrier 3014, then the benefits (e.g., discounts) may be shared among all the vendors whose orders comprise the aggregated order. If the vendor decides to provide the customer 3000 with the shipping discount or to share the discounts with the customer 3000, then the shipping options are presented to the customer 3000 by, for example, displaying them on the vendor's website, emailing them to the customer 3000, reciting the options to the customer 3000 over the telephone, or otherwise audibly or visually making the customer 3000 aware of the shipping options. Under one option, the customer is provided the opportunity to combine the delivery of the present order with one or more earlier orders. This may be accomplished by the carrier 3014 holding the earlier shipped orders until the most recent order can be combined with the earlier orders by the carrier 3014, thus reducing the delivery trips by the carrier 3014 to the customer 3000. Another option would be for the customer 3000 to choose to upgrade the class of service (e.g., go from three-day ground to next-day air) of the present order. In this manner, the present order may be combined with one or more of the earlier orders by the carrier 3014 and delivered substantially simultaneously to the customer 3000 by the carrier 3014.

Once the shipping options are selected by the customer 3000 (if made available to the customer), the items that comprise the present order are presented to the carrier 3014 for shipment. Generally, the items are picked-up by the carrier 3014 at the present vendor's place of business and transported to a carrier facility by a package car 3016, though in other embodiments the items may be dropped off at the carrier's facility. The items that comprise the present order will be aggregated with items that comprise one or more earlier orders. The aggregated orders will then be loaded on a package car 3016 or other means for transporting the aggregated orders to the customer 3000, transported to the customer 3000, and delivered substantially simultaneously by the carrier 3014.

FIG. 31 is a system for substantially simultaneously delivering a plurality of packages containing items that have been ordered in separate orders from one or more vendors to a customer that has ordered the items. The embodiment of FIG. 31 is similar to that of FIG. 30; however, the embodiment of FIG. 31 is further comprised of a carrier's pre-load facility 3102. The pre-load facility 3102 allows the carrier 3014 to delay the delivery of one or more orders that the orders may be aggregated into a single delivery to the customer 3000 by the carrier 3014. For instance, if the customer 3000 wants to aggregate a most-recent order with one or more earlier orders, the customer 3000 authorizes the carrier 3014 to issue a merge/sort order to the pre-load facility 3102 so that the items that comprise the one or more earlier orders will be held at the pre-load facility 3102 until they can be aggregated with the items that comprise the most recently placed order for a substantially simultaneous delivery of the aggregated items to the customer 3000.

In one embodiment the merge/hold instruction electronically links through the use of computers the package tracking information of the items that comprise the earlier orders with the package tracking information of the items that comprise the most recent order so that the items that arrive earliest at the pre-load facility 3102 are held until all the linked items are received and form a single delivery to the customer 3000.

Thus, the embodiments of the present invention describe systems and methods for the aggregated delivery of a plurality of parcels to a delivery location such as, for example, a residence, business, etc. Such aggregated delivery increases the parcels per delivery of the carrier, decreases the number of deliveries per location, yet still provides a high level of service to the shippers and the intended recipient.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of aggregating the delivery of parcels to a customer by a carrier, said method comprising:
placing a first parcel in a first shipping route to the customer, said first parcel having a known first delivery date;
requesting delivery of a second parcel and determining an expected second delivery date of the second parcel in a second shipping route to the customer if said second parcel is shipped essentially at the time said request for delivery of the second parcel is made, said expected second delivery date being different from said first delivery date and said expected second delivery date being earlier than said first delivery date; and
delaying shipment of the second parcel by withholding transfer of said second parcel to the carrier such that the expected second delivery date coincides with the first delivery date and the first parcel and the second parcel are delivered in a single delivery to the customer on the first delivery date.

2. The method of claim 1, wherein the carrier provides a shipping rate that is discounted from the carrier's normal shipping rate for the second parcel.

3. The method of claim 1, wherein the first parcel is shipped by a first shipper and the second parcel is shipped by a second shipper and the first shipper and the second shipper share a monetary rebate provided by the carrier.

4. A method of aggregating the delivery of parcels to a customer by a carrier, said method comprising:
placing a first parcel in a first shipping route to the customer, said first parcel having a known first delivery date;
placing a second parcel in a second shipping route to the customer, said second parcel having a second delivery date being different from said first delivery date and said second delivery date being later than said first delivery date; and
expediting delivery of the second parcel by using a higher class of service offered by the carrier for the second parcel at the time the second parcel is transferred to the carrier for delivery such that the second delivery date coincides with the first delivery date and the first parcel and the second parcel are delivered in a single delivery to the customer on the first delivery date.

5. The method of claim 4, wherein the carrier provides a shipping rate that is discounted from the carrier's normal shipping rate for the second parcel.

6. The method of claim 4, wherein the first parcel is shipped by a first shipper and the second parcel is shipped by a second shipper and the first shipper and the second shipper share a monetary rebate provided by the carrier.

7. A method of aggregating the delivery of parcels to a customer by a carrier, said method comprising:
placing a first parcel in a first shipping route to the customer, said first parcel having a known first delivery date;
placing a second parcel in a second shipping route to the customer, said second parcel having a known second delivery date being different from said first delivery date and said second delivery date being later than said first delivery date;
delaying delivery of the first parcel by the carrier such that the second delivery date coincides with the first delivery date and the first parcel and the second parcel are delivered in a single delivery to the customer on the second delivery date; and providing a shipping rate to a shipper of the second parcel that is discounted from the carrier's normal shipping rate for the second parcel.

8. The method of claim 7, wherein the first parcel is shipped by a first shipper and the second parcel is shipped by a second shipper and the first shipper and the second shipper share a monetary rebate provided by the carrier.

9. The method of claim 7, wherein delaying delivery of the first parcel by the carrier is accomplished by the carrier issuing instructions to a pre-load facility for the first parcel such that the first parcel is held at the pre-load facility until it is consolidated with the second parcel and delivered in a single delivery to the customer on the second delivery date.

10. A method of aggregating the delivery of parcels to a customer by a carrier, said method comprising:
shipping a first parcel to the customer, said first parcel having a known first delivery date;
requesting delivery of a second parcel and determining an expected second delivery date of the second parcel if said second parcel is shipped to the customer essentially at the time said request for delivery of the second parcel is made, said expected second delivery date being different from said first delivery date;
if said expected second delivery date is before the first delivery date then delaying shipment of the second parcel by withholding transfer of the second parcel to the carrier such that the expected second delivery date coincides with the first delivery date and the first parcel and the second parcel are delivered in a single delivery to the customer on the first delivery date; and
if said expected second delivery date is after the first delivery date then shipping said second parcel and expediting delivery of the second parcel by using a higher class of service offered by the carrier for the second parcel at the time the second parcel is transferred to the carrier such that the expected second delivery date coincides with the first delivery data and the first parcel and the second parcel are delivered in a single delivery to the customer on the first delivery date.

11. The method of claim 10, wherein the carrier provides a shipping rate that is discounted from the carrier's normal shipping rate for the second parcel.

12. The method of claim 10, wherein the first parcel is shipped by a first shipper and the second parcel is shipped by a second shipper and the first shipper and the second shipper share a monetary rebate provided by the carrier.

13. A method of aggregating the delivery of parcels to a customer by a carrier, said method comprising:
shipping a first parcel to the customer, said first parcel having a known first delivery date;
shipping a second parcel to the customer, said second parcel having a known second delivery date that is different from the first delivery date;
if said second delivery date is before the first delivery date then expediting delivery of the first parcel by utilizing a higher class of service offered by the carrier for the first parcel such that the second delivery date coincides with the first delivery date and the first parcel and the second parcel are delivered in a single delivery to the customer on the second delivery date and providing a shipping rate to a shipper of the first parcel that is discounted from the carrier's normal shipping rate for the first parcel; and
if said second delivery date is after the first delivery date then delaying delivery of the first parcel by the carrier such that the second delivery date coincides with the first delivery data and the first parcel and the second parcel are delivered in a single delivery to the customer on the second delivery date and providing a shipping rate to shipper of the second parcel that is discounted from the carrier's normal shipping rate for the second parcel.

14. The method of claim 13, wherein the first parcel is shipped by a first shipper and the second parcel is shipped by a second shipper and the first shipper and the second shipper share a monetary rebate provided by the carrier.

15. The method of claim 13, wherein delaying delivery of the first parcel by the carrier is accomplished by the carrier issuing instructions to a pre-load facility for the first parcel such that the first parcel is held at the pre-load facility until it is consolidated with the second parcel and the first parcel and the second parcel are delivered in a single delivery to the customer on the second delivery date.

16. A method of aggregating the delivery of parcels to a customer by a carrier, said method comprising:
shipping a first parcel to the customer, said first parcel having a known first delivery date;
shipping a second parcel to the customer, said second parcel having a known second delivery date that is different from said first delivery date;
if said second delivery date is before the first delivery date then delaying delivery of the second parcel by the carrier such that the second delivery date coincides with the first delivery data and the first parcel and the second parcel are delivered in a single delivery to the customer on the first delivery date and providing a shipping rate to the shipper of the second parcel that is discounted from the carrier's normal shipping rate for the second parcel; and
if said second delivery date is after the first delivery date then delaying delivery of the first parcel by the carrier such that the second delivery date coincides with the first delivery data and the first parcel and the second parcel are delivered in a single delivery to the customer on the second delivery date and providing a shipping rate to the shipper of the first parcel that is discounted from the carrier's normal shipping rate for the first parcel.

17. The method of claim 16, wherein the first parcel is shipped by a first shipper and the second parcel is shipped by a second shipper and the first shipper and the second shipper share a monetary rebate provided by the carrier.

18. The method of claim 16, wherein delaying delivery of the first parcel by the carrier is accomplished by the carrier issuing instructions to a pre-load facility for the first parcel such that the first parcel is held at the pre-load facility until it is consolidated with the second parcel and the first parcel and the second parcel are delivered in a single delivery to the customer on the second delivery date.

19. The method of claim 16, wherein delaying delivery of the second parcel by the carrier is accomplished by the carrier issuing instructions to a pre-load facility for the second parcel such that the second parcel is held at the pre-load facility until it is consolidated with the first parcel and the first parcel and the second parcel are delivered in a single delivery to the customer on the first delivery date.

20. A method of aggregating the delivery of a plurality of parcels to a customer by a carrier, said method comprising:
placing one or more earlier parcels in one or more shipping routes to the customer, each said earlier parcel having a known earlier delivery date;
requesting delivery of a last-in-time parcel and determining an expected last-in-time delivery date of a last-in-time parcel in a last-in-time shipping route to the customer if said last-in-time parcel is shipped to the customer at essentially the time that said request for delivery of the last-in-time parcel is made, said expected last-in-time delivery date being different from said each known earlier delivery date and said expected last-in-time delivery date being earlier than said each known earlier delivery date; and
delaying shipment of the last-in-time parcel by withholding transfer of the last-in-time parcel to the carrier such that the expected last-in-time delivery date coincides with one or more of the earlier delivery dates and one or more of the earlier parcels and the last-in-time parcel are delivered in a single delivery to the customer on one of the earlier delivery dates.

21. The method of claim 20, wherein the carrier provides a shipping rate that is discounted from the carrier's normal shipping rate for the last-in-time parcel.

22. The method of claim 20, wherein the one or more earlier parcels are shipped by one or more earlier shippers and the last-in-time parcel is shipped by a last-in-time shipper and the one or more earlier shippers and the last-in-time shipper share a monetary rebate provided by the carrier.

23. A method of aggregating the delivery of a plurality of parcels to a customer by a carrier, said method comprising:
placing one or more earlier parcels in one or more earlier shipping routes to the customer, said one or more earlier parcels each having a known earlier delivery date;
placing a last-in-time parcel in a last-in-time shipping route to the customer, said last-in-time parcel having a last-in-time delivery date being different from said one or more earlier delivery dates and said last-in-time delivery date being later than said one or more earlier delivery dates; and
expediting delivery of the last-in-time parcel by using a higher class of service offered by the carrier for the last-in-time parcel at the time of transfer of the last-in-time parcel to the carrier such that the last-in-time delivery date coincides with one or more of the earlier delivery dates and one or more of the earlier parcels and the last-in-time parcel are delivered in a single delivery to the customer on one of the earlier delivery dates.

24. The method of claim 23, wherein the carrier provides a shipping rate that is discounted from the carrier's normal shipping rate for the last-in-time parcel.

25. The method of claim 23, wherein the one or more earlier parcels are shipped by one or more earlier shippers and the last-in-time parcel is shipped by a last-in-time shipper and the one or more earlier shippers and the last-in-time shipper share a monetary rebate provided by the carrier.

26. A method of aggregating the delivery of a plurality of parcels to a customer by a carrier, said method comprising:
placing one or more earlier parcels in one or more earlier shipping routes to the customer, said one or more earlier parcels each having known earlier delivery dates;
placing a last-in-time parcel in a last-in-time shipping route to the customer, said last-in-time parcel having a known last-in-time delivery date being different from said earlier delivery dates and said last-in-time delivery date being later than said earlier delivery dates;
delaying delivery of the one or more earlier parcels by the carrier such that each of the earlier delivery dates coincide with the last-in-time delivery date and the one or more earlier parcels and the last-in-time parcel are delivered in a single delivery to the customer on the last-in-time delivery date; and
providing a shipping rate to a shipper of the last-in-time parcel that is discounted from the carrier's normal shipping rate for the last-in-time parcel.

27. The method of claim 26, wherein the one or more earlier parcels are shipped by one or more earlier shippers and the last-in-time parcel is shipped by a last-in-time shipper and the one or more earlier shippers and the last-in-time shipper share a monetary rebate provided by the carrier.

28. The method of claim 26, wherein delaying delivery of the one or more earlier parcels by the carrier is accomplished by the carrier issuing instructions to a pre-load facility for the one or more earlier parcels such that the one or more earlier parcels are held at the pre-load facility until they are consolidated with the last-in-time parcel and delivered in a single delivery to the customer on the last-in-time delivery date.

29. A method of aggregating the delivery of a plurality of parcels to a customer by a carrier, said method comprising:
shipping one or more earlier parcels to the customer, said one or more earlier parcels each having known earlier delivery dates;
requesting delivery of a last-in-time parcel and determining an expected last-in-time delivery date of the last-in-time parcel if said last-in-time parcel is shipped to the customer at essentially the time that said request for delivery of the last-in-time parcel is made, said expected last-in-time delivery date being different from said earlier delivery dates;
if said expected last-in-time delivery date is before the earlier delivery dates then delaying shipment of the last-in-time parcel by withholding transfer of the last-in-time parcel to the carrier such that the expected last-in-time delivery date coincides with one or more of the earlier delivery dates and one or more of the earlier parcels and the last-in-time parcel are delivered in a single delivery to the customer on one of the earlier delivery dates; and
if said expected last-in-time delivery date is after the earlier delivery dates then shipping said last-in-time parcel and expediting delivery of the last-in-time parcel by using a higher class of service offered by the carrier for the last-in-time parcel at the time the last-in-time parcel is transferred to the carrier such that the expected last-in-time delivery date coincides with one or more of the earlier delivery dates and one or more of the earlier parcels and the last-in-time parcel are delivered in a single delivery to the customer on one of the earlier delivery dates.

30. The method of claim 29, wherein the carrier provides a shipping rate that is discounted from the carrier's normal shipping rate for the last-in-time parcel.

31. The method of claim 29, wherein the one or more earlier parcels are shipped by one or more earlier shippers and the last-in-time parcel is shipped by the last-in-time shipper and the one or more earlier shippers and the last-in-time shipper share a monetary rebate provided by the carrier.

32. A method of aggregating the delivery of a plurality of parcels to a customer by a carrier, said method comprising:
shipping one or more earlier parcels to the customer, said one or more earlier parcels each having known earlier delivery dates;
shipping a last-in-time parcel to the customer, said last-in-time parcel having a known last-in-time delivery date that is different from the earlier delivery dates;
if said last-in-time delivery date is before the earlier delivery dates then expediting delivery of one or more of the earlier parcels by utilizing a higher class of service offered by the carrier for one or more of the earlier parcels such that one or more of the earlier delivery dates coincide with the last-in-time delivery date and one or more of the earlier parcels and the last-in-time parcel are delivered in a single delivery to the customer on the last-in-time delivery date;
if said last-in-time delivery date is after the one or more earlier delivery dates then delaying delivery of one or more of the earlier parcels by the carrier such that one or more of the earlier delivery dates coincide with the last-in-time delivery data and one or more of the earlier parcels and the last-in-time parcel are delivered in a single delivery to the customer on the last-in-time delivery date; and
and providing a shipping rate to the one or more shippers of the one or more earlier parcels that is discounted from the carrier's normal shipping rate for the last-in-time parcel.

33. The method of claim 32, wherein the one or more earlier parcels are shipped by one or more earlier shippers and the last-in-time parcel is shipped by a last-in-time shipper and the one or more earlier shippers and the last-in-time shipper share a monetary rebate provided by the carrier.

34. The method of claim 32, wherein delaying delivery of one or more of the earlier parcels by the carrier is accomplished by the carrier issuing instructions to a pre-load facility for one or more of the earlier parcels such that one or more of the earlier parcels are held at the pre-load facility until they are consolidated with the last-in-time parcel and one or more of the earlier parcels and the last-in-time parcels are delivered in a single delivery to the customer on the last-in-time delivery date.

35. A method of aggregating the delivery of a plurality of parcels to a customer by a carrier, said method comprising:
shipping one or more earlier parcels to the customer, said one or more earlier parcels each having known earlier delivery dates;
shipping a last-in-time parcel to the customer, said last-in-time parcel having a known last-in-time delivery date that is different from said earlier delivery dates;
if said last-in-time delivery date is before the one or more earlier delivery dates then delaying delivery of the last-in-time parcel by the carrier such that the last-in-time delivery date coincides with one or more of the earlier delivery dates and one or more of the earlier parcels and the last-in-time parcel are delivered in a single delivery to the customer on one of the earlier delivery dates and providing a shipping rate to the shipper of the last-in-time parcel that is discounted from the carrier's normal shipping rate for the last-in-time parcel; and
if said last-in-time delivery date is after the one or more earlier delivery dates then delaying delivery of one or more of the earlier parcels by the carrier such that the last-in-time delivery date coincides with one or more of the earlier delivery dates and one or more of the earlier parcels and the last-in-time parcel are delivered in a single delivery to the customer on the last-in-time delivery date and providing a shipping rate to the one or more earlier shippers of the one or more earlier parcels that is discounted from the carrier's normal shipping rate for the one or more earlier parcels.

36. The method of claim 35, wherein the one or more earlier parcels are shipped by a one or more earlier shippers and the last-in-time parcel is shipped by a last-in-time shipper and the one or more earlier shippers and the last-in-time shipper share a monetary rebate provided by the carrier.

37. The method of claim 35, wherein delaying delivery of one or more of the earlier parcels by the carrier is accomplished by the carrier issuing instructions to a pre-load facility for one or more of the earlier parcels such that one or more of the earlier parcels are held at the pre-load facility until it is consolidated with the last-in-time parcel and one or more of the earlier parcels and the last-in-time parcel are delivered in a single delivery to the customer on the last-in-time delivery date.

38. The method of claim 35, wherein delaying delivery of the last-in-time parcel by the carrier is accomplished by the carrier issuing instructions to a pre-load facility for the last-in-time parcel such that the last-in-time parcel is held at the pre-load facility until it is consolidated with one or more of the earlier parcels and one or more of the earlier parcels and the last-in-time parcel are delivered in a single delivery to the customer on one of the earlier delivery dates.

39. A method of shipping parcels to a customer, comprising:
placing a first parcel in a first shipping route having a first delivery date to the customer;
evaluating the placement of a second parcel in a second shipping route to the customer, wherein such evaluation includes determining an expected second delivery date if said second parcel was shipped essentially at the time of making the evaluation of the placement of the second parcel;
if said first delivery date and said expected second delivery date are the same, then shipping said second parcel essentially at the time of making the evaluation of the placement of the second parcel; and
if said expected second delivery date is before said first delivery date, delaying placement of said second parcel into said second shipping route until a time that placement of said second parcel into said second delivery route would result in the first and second parcels being delivered the same day.

40. The method of claim 39 further comprising if said expected second delivery date is after said first delivery date, then placing said second parcel into said second shipping route at a higher class of service with a carrier such that delivery of said second parcel is expedited by said carrier and results in said first parcel and said second parcel being delivered the same day.

41. The method of claim 39 further comprising if said expected second delivery date is after said first delivery date, then placing said second parcel into said second shipping route with a carrier and having said first parcel held by said carrier such that said first parcel and said second parcel are delivered the same day and providing a shipping rate to the shipper of the first parcel that is discounted from the carrier's normal shipping rate for the first parcel.

42. A method of shipping parcels to a customer by a carrier, comprising:
receiving a first parcel to be delivered to the customer, said first parcel placed in a first shipping route to the customer and having a first delivery date;
receiving a second parcel to be delivered to the customer, said second parcel placed in a second shipping route to the customer and having a second delivery date;
if said first delivery date and said second delivery date are the same, then delivering said first and second parcels accordingly; and
if said second delivery date is before said first delivery date, then holding said second parcel until a time that would result in the first and second parcels being delivered the same day and providing a shipping rate to the shipper of the second parcel that is discounted from the carrier's normal shipping rate for the second parcel.

43. The method of claim 42 further comprising if said expected second delivery date is after said first delivery date, then receiving from a shipper of the second parcel said second parcel at a higher class of delivery service such that delivery of said second parcel is expedited by said carrier and results in said first parcel and said second parcel being delivered the same day.

44. The method of claim 42 further comprising if said expected second delivery date is after said first delivery date, then holding said first parcel until a time that would result in the first and second parcels being delivered the same day and providing a shipping rate to the shipper of the first parcel that is discounted from the carrier's normal shipping rate for the first parcel.

45. A method of delivering parcels, comprising:
placing a first parcel in a first shipping route to a location, said first parcel having a first package tracking identifier and a first delivery date placing a second parcel in a second shipping route to the location, said second parcel having a second package tracking identifier and a second delivery date;
delaying either of said first or second parcels along their respective shipping routes so that they arrive at the location at substantially the same time; and
providing a shipping rate to at least one of a shipper of the first parcel and a shipper of the second shipper that is discounted from the carrier's normal shipping rate for the first or second parcel, respectively.

46. The method of claim 45, wherein said first shipping route and said second shipping route are different routes.

47. The method of claim 45, wherein said first shipping route and said second shipping route are the same route.

48. The method of claim 45, wherein either of said first or second parcels are delayed at a pre-load facility controlled by a carrier.

49. The method of claim 45, wherein said first and second parcels are delivered to the location in the same carrier's package car.

50. A method of delivering a plurality of parcels to a customer via a carrier, comprising:
coordinating a shipment date for each of a plurality of parcels shipped by one or more shippers to a customer on a substantially consistent time interval such that the plurality of parcels are delivered to the customer by the carrier at substantially the same time; and
receiving the plurality of parcels that are shipped from one or more shippers on each parcels designated shipment date and delivering said plurality of parcels to the customer at substantially the same time.

51. The method of claim 50, further comprising the customer subscribing to a program that authorizes the carrier to coordinate the shipment of the plurality of parcels shipped by the one or more shippers.

52. The method of claim 50, further comprising the carrier providing a discounted shipping rate to the one or more shippers for the plurality of parcels shipped by the one or more shippers.

53. The method of claim 50, further comprising the carrier providing a monetary rebate to the one or more shippers.

54. A method of delivering a plurality of parcels to a customer via a carrier, comprising:
subscribing, by a customer, to a program that authorizes the carrier to coordinate the shipment of a plurality of parcels shipped by one or more shippers to the customer;
coordinating a shipment date for each of a plurality of parcels shipped by the one or more shippers to the customer on a substantially consistent time interval such that the plurality of parcels are delivered to the customer by the carrier at substantially the same time;
receiving the plurality of parcels that are shipped from one or more shippers on each parcel's designated shipment date and delivering said plurality of parcels to the customer at substantially the same time; and
providing a discounted shipping rate to the one or more shippers for the plurality of parcels that are shipped by the one or more shippers.

55. A method of delivering a plurality of parcels that are shipped to a customer via a carrier, comprising:
receiving a plurality of parcels that are shipped from one or more shippers via a carrier and to a customer on a substantially consistent time interval with the plurality of parcels having more than one delivery date;
coordinating a preferred delivery date with the customer such that the plurality of parcels are delivered to the customer by the carrier at substantially the same time; and
holding one or more or all of the plurality of parcels until the preferred delivery date and delivering the plurality of parcels to the customer at substantially the same time on the preferred delivery date.

56. The method of claim 55, further comprising the customer subscribing to a program that authorizes the carrier to coordinate the delivery of the plurality of parcels shipped by the one or more shippers.

57. The method of claim 55, further comprising the carrier providing a discounted shipping rate to the one or more shippers for the plurality of parcels shipped by the one or more shippers.

58. The method of claim 55, further comprising the carrier providing a monetary rebate to the one or more shippers.

59. A method of delivering a plurality of parcels that are shipped to a customer via a carrier, comprising:
subscribing, by the customer, to a program that authorizes a carrier to coordinate the delivery of a plurality of parcels shipped by one or more shippers to a customer;
receiving the plurality of parcels that are shipped from one or more shippers via a carrier and to a customer on a substantially consistent time interval with the plurality of parcels having more than one delivery date;
coordinating a preferred delivery date with the customer such that the plurality of parcels are delivered to the customer by the carrier at substantially the same time;
holding one or more or all of the plurality of parcels until the preferred delivery date and delivering the plurality of parcels to the customer at substantially the same time on the preferred delivery date; and
providing a discounted shipping rate to the one or more shippers for the plurality of parcels that are shipped by the one or more shippers.

60. A method of delivering a plurality of parcels that are shipped to a customer via a carrier, comprising:
receiving a plurality of parcels that are shipped from one or more shippers via a carrier and to a customer on a substantially consistent time interval with the plurality of parcels having more than one delivery date; and
coordinating a preferred delivery date with the customer such that the plurality of parcels are delivered to the customer by the carrier at substantially the same time by accelerating the delivery of some parcels that comprise the plurality of parcels and delaying the delivery of delaying the delivery of some parcels that comprise the plurality of parcels until the preferred delivery date and delivering the plurality of parcels to the customer at substantially the same time on the preferred delivery date.

61. A method of aggregated delivery for ordered items, comprising:
accessing a first vendor's website and ordering one or more items that are shipped via a carrier in at least one first parcel having a first package tracking identifier, wherein said first parcel has a known first delivery date;
receiving from the first vendor the first package tracking identifier;
accessing a second vendor's website and ordering one or more items that are shipped via the carrier in at least one second parcel having a second package tracking identifier, wherein said second parcel has a known second delivery date that is different from the first delivery date;
providing the second vendor with the first package tracking identifier;
agreeing to have the second vendor delay the shipment of the second parcel if the second delivery date is before the first delivery date, wherein said first and second parcels can be delivered substantially simultaneously on the first delivery date; and
agreeing to have the second vendor ship the second shipment using an expedited class of delivery service of the carrier for the second parcel if the second delivery date is after the first delivery date, wherein said first and second parcels can be delivered substantially simultaneously on the first delivery date.

62. A method of aggregated delivery for ordered items, comprising:
accessing a first vendor's website and ordering one or more items that are shipped via a carrier in at least one first parcel having a first package tracking identifier, wherein said first parcel has a known first delivery date;
receiving from the first vendor the first package tracking identifier;
accessing a second vendor's website and ordering one or more items that are shipped via the carrier in at least one second parcel having a second package tracking identifier, wherein said second parcel has a known second delivery date that is different from the first delivery date;
providing the second vendor with the first package tracking identifier;
agreeing to have the carrier delay the delivery of the second parcel by holding said second parcel until the time said second parcel is aggregated with said first parcel if the second delivery date is before the first delivery date and providing a shipping rate to the second vendor that is discounted from the carrier's normal shipping rate for the second parcel, wherein said first and second parcels can be delivered substantially simultaneously on the first delivery date; and
agreeing to have the carrier delay the delivery of the first parcel by holding said first parcel until the time said first parcel is aggregated with said second parcel if the second delivery date is after the first delivery date and providing a shipping rate to the first vendor that is discounted from the carrier's normal shipping rate for the first parcel, wherein said first and second parcels can be delivered substantially simultaneously on the second delivery date.

63. A method of choosing the service level for delivery of a parcel by a carrier, said method comprising:
placing a first parcel in a first shipping route to a customer, said first parcel having a known first delivery date;
determining an expected second delivery date of a second parcel in a second shipping route to the customer if said second parcel is shipped immediately using one or more service levels for delivery offered by the carrier;
choosing a service level for delivery offered by the carrier so that if the second parcel is shipped immediately sing the chosen service level of delivery offered by the carrier, the first and second parcels are delivered in a single delivery to the customer on the first delivery date; and
shipping said second parcel using the chosen service level for delivery.

64. The method of claim 63, wherein the carrier provides a shipping rate that is discounted from the carrier's normal shipping rate for the second parcel.

65. The method of claim 63, wherein the first parcel is shipped by a first shipper and the second parcel is shipped by a second shipper and the first shipper and the second shipper share a monetary rebate provided by the carrier.
